(19) United States
(12) Patent Application Publication
(10) Pub. No.: US 2012/0317516 A1
(43) Pub. Date: Dec. 13, 2012

(54) INFORMATION PROCESSING DEVICE, INFORMATION PROCESSING METHOD, AND RECORDING MEDIUM

(75) Inventor: Tsuyoshi Ohsumi, Tokyo (JP)

(73) Assignee: CASIO COMPUTER CO., LTD., Tokyo (JP)

(21) Appl. No.: 13/489,917

(22) Filed: Jun. 6, 2012

(30) Foreign Application Priority Data
Jun. 9, 2011 (JP) 2011-129013
Feb. 27, 2012 (JP) 2012-040193

(51) Int. Cl. G06F 3/048

(52) U.S. Cl. 715/849

(57) ABSTRACT

An information processing device includes an input operation acceptance unit, distance specification unit, and control unit. The input operation acceptance unit accepts movement of a body substantially parallel to a display surface (two-dimensional plane) of a display unit in which touch panels are laminated, as a touch operation to the touch panel. The distance specification unit detects a distance of the body when a touch operation is made from the display surface (two-dimensional plane) of the display unit. The control unit variably controls the execution of processing related to an object displayed, based on the type of touch operation accepted by the input operation acceptance unit (types differ depending on the trajectory of movement of the body), and the distance detected by the distance specification unit.

This application is based on and claims the benefit of priority from Japanese Patent Applications Nos. 2011-129013 and 2012-040193, respectively filed on 9 Jun. 2011 and 27 Feb. 2012, the content of which is incorporated herein by reference.

### BACKGROUND OF THE INVENTION

1. Field of the Invention

The present invention relates to an information processing device, information processing method, and recording medium.

2. Related Art

In recent years, the demand has been rising for information processing devices equipped with a touch panel laminated on a display unit such as a liquid crystal display. Information processing devices executes processing related to objects displayed on the display unit, based on operations in accordance with the contact or near contact of a body such as a finger of the user or a touch pen to the touch panel (hereinafter referred to as “touch operation”) (refer to Japanese Unexamined Patent Application, Publication No. H07-334308; Japanese Utility Model Registration No. 3150179; Japanese Unexamined Patent Application, Publication No. 2009-26155; Japanese Unexamined Patent Application, Publication No. 2006-236143; and Japanese Unexamined Patent Application, Publication No. 2000-163031).

However, even when adopting the technologies described in Japanese Unexamined Patent Application, Publication No. H07-334308; Japanese Utility Model Registration No. 3150179; Japanese Unexamined Patent Application, Publication No. 2009-26155; Japanese Unexamined Patent Application, Publication No. 2006-236143; and Japanese Unexamined Patent Application, Publication No. 2000-163031, a problem arises in that processing related to an object will not be appropriately performed unless a complicated touch operation is made.

Such a problem arises not only for touch panels, but for all existing operations to cause a body such as a finger to contact or nearly contact an input device or the like, such as an operation to contact an input device, e.g., an operation to depress a key of a keyboard and an operation to click a mouse.

### SUMMARY OF THE INVENTION

The present invention has been made taking such a situation into account, and has an object of enabling easy instruction of processing on an object, even for a user inexperienced in existing operations.

According to a first aspect of the present invention, an information processing device is provided that includes:

a three-dimensional position detection means for detecting a position of a body relative to a reference plane in three-dimension directions;

a three-dimensional operation acceptance means for recognizing movement of the body in three-dimensional directions based on each position in three-dimensional directions of the body temporally separated and detected multiple times, by way of the three-dimensional position detection unit, and accepts a recognition result thereof as an instruction operation related to an object; and

a control means for variably controlling processing related to the object, depending on the instruction operation accepted by the three-dimensional operation acceptance unit and a distance of the body in a normal vector direction from the reference plane.

According to a second aspect of the present invention, a information processing device is provided that includes:

a three-dimensional position detection means for detecting a position of a body relative to a reference plane in three-dimension directions;

a three-dimensional operation acceptance means for recognizing movement of the body in three-dimensional directions based on each position in three-dimensional directions of the body temporally separated and detected multiple times, by way of the three-dimensional position detection means, and accepting a recognition result thereof as an instruction operation related to an object; and

a control means for variably controlling processing related to the object, depending on the instruction operation accepted by way of the three-dimensional operation acceptance function.

### BRIEF DESCRIPTION OF THE DRAWINGS

FIG. 1 is a block diagram showing the configuration of the hardware for an information processing device according to a first embodiment of the present invention;

FIG. 2 is a functional block diagram showing, among the functional configurations of the information processing device in FIG. 1, a functional configuration for executing input operation acceptance processing;

FIG. 3 is a cross-sectional view showing a part of an input unit of the information processing device in FIG. 1;

FIG. 4 is a flowchart illustrating the flow of input operation acceptance processing of the first embodiment executed by the information processing device of FIG. 1 having the functional configuration of FIG. 2;

FIGS. 5A and 5B are views showing states in which a flick operation is made on the input unit of the information processing device of FIG. 1;

FIG. 6 is a flowchart illustrating the flow of input operation acceptance processing of a second embodiment executed by the information processing device of FIG. 1 having the functional configuration of FIG. 2;

FIGS. 7A and 7B are views showing states in which a flick operation is made such as that to make a circle on the input unit of the information processing device of FIG. 1;

FIG. 8 is a view illustrating a display example displayed on a display unit of the information processing device of FIG. 1 having the functional configuration of FIG. 2;

FIG. 9 is a flowchart illustrating the flow of input operation acceptance processing of a third embodiment executed by the information processing device of FIG. 1 having the functional configuration of FIG. 2;

FIG. 10 is a flowchart illustrating the flow of input operation acceptance processing of a fourth embodiment executed by the information processing device of FIG. 1 having the functional configuration of FIG. 2;

FIGS. 11A and 11B are views showing states in which touch-down and touch-up operations are made on the input unit of the information processing device in FIG. 1;

FIG. 12 is a flowchart illustrating the flow of input operation acceptance processing of a fifth embodiment executed by the information processing device of FIG. 1 having the functional configuration of FIG. 2;

FIGS. 13A and 13B are views showing states in which a flick operation is made on the input unit of the information processing device in FIG. 1;

FIG. 14 is a flowchart illustrating the flow of input operation acceptance processing of a sixth embodiment executed by the information processing device of FIG. 1 having the functional configuration of FIG. 2;

FIGS. 15A and 15B are views showing states in which a flick operation is made on an input unit 17 of the information processing device in FIG. 1, while bringing a finger close thereto or keeping away therefrom;

FIG. 16 is a flowchart illustrating the flow of input operation acceptance processing of a seventh embodiment executed by the information processing device of FIG. 1 having the functional configuration of FIG. 2;

FIG. 17 is a view showing a display example of a character stroke corresponding to trajectory data prepared based on the coordinates of each position of a finger moved from touch-down until touch-up;

FIG. 18 is a flowchart illustrating the flow of input operation acceptance processing of an eighth embodiment executed by the information processing device of FIG. 1 having the functional configuration of FIG. 2;

FIG. 19 is a view showing a state in which a touch operation is made on the input unit 17 of the information processing device of FIG. 1;

FIG. 20 is a flowchart illustrating the flow of input operation acceptance processing of a ninth embodiment executed by the information processing device of FIG. 1 having the functional configuration of FIG. 2;

FIG. 21 is a view showing a state in which a touch operation is made on the input unit of the information processing device of FIG. 1;

FIG. 22 is a block diagram showing the configuration of hardware of an information processing device according to an embodiment of the present invention;

FIG. 23 is a functional block diagram showing, among the functional configurations of the information processing device in FIG. 22, the functional configuration for executing input operation acceptance processing;

FIG. 24 is a cross-sectional view showing a part of an input unit of the information processing device of FIG. 22;

FIG. 25 is a flowchart illustrating the flow of input operation acceptance processing executed by the information processing device of FIG. 22 having the functional configuration of FIG. 23;

FIGS. 26A, 26B, 26C and 26D show states in which a touch operation is made on the input unit of the information processing device of FIG. 22;

FIGS. 27A and 27B show states in which a flick operation is made on the input unit of the information processing device of FIG. 22;

FIGS. 28A and 28B show states in which an operation to clench or open a hand is made above the input unit of the information processing device of FIG. 22; and

FIGS. 29A and 29B show states in which a rotation operation is made on the input unit of the information processing device of FIG. 22.

### DETAILED DESCRIPTION OF THE INVENTION

Hereinafter, embodiments of the present invention will be explained using the attached drawings.

### First Embodiment

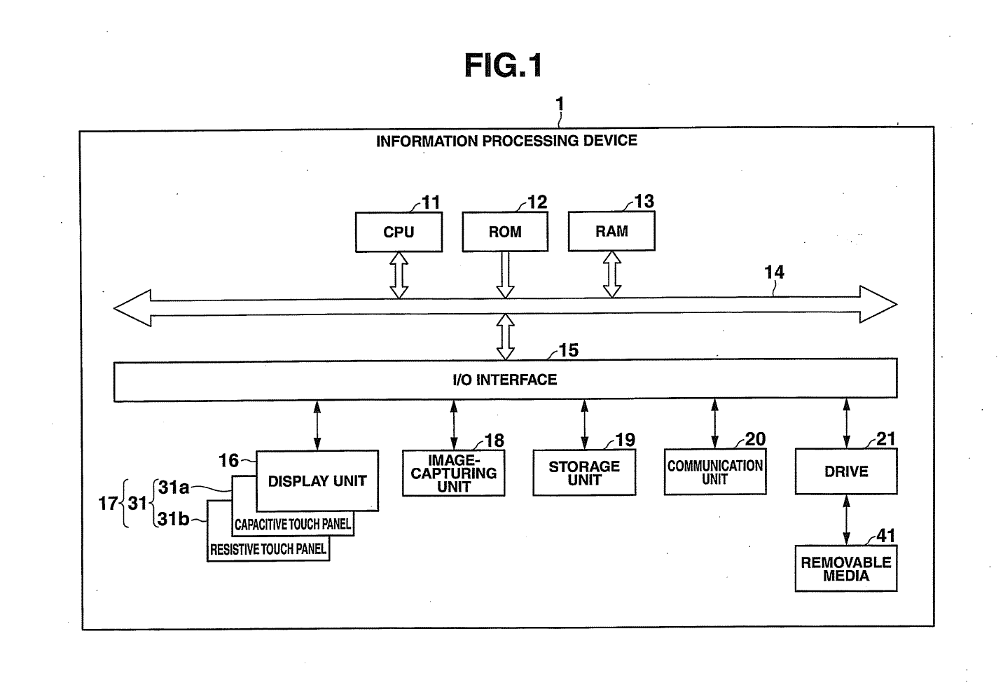

FIG. 1 is a block diagram showing the configuration of the hardware of an information processing device according to a first embodiment of the present invention.

An information processing device 1 is configured as a smart phone, for example.

The information processing device 1 includes: a CPU (Central Processing Unit) 11, ROM (Read Only Memory) 12, RAM (Random Access Memory) 13, a bus 14, an I/O interface 15, a display unit 16, an input unit 17, an image-capturing unit 18, a storage unit 19, a communication unit 20, and a drive 21.

The CPU 11 executes a variety of processing in accordance with a program recorded in the ROM 12, or a program loaded from the storage unit 19 into the RAM 13.

The necessary data and the like upon the CPU 11 executing the variety of processing are also stored in the RAM 13 as appropriate.

The CPU 11, ROM 12 and RAM 13 are connected to each other through the bus 14. The I/O interface 15 is also connected to this bus 14. The display unit 16, input unit 17, image-capturing unit 18, storage unit 19, communication unit 20 and drive 21 are connected to the I/O interface 15.

The display unit 16 is configured by a display, and displays images.

The input unit 17 is configured by a touch panel 31 that is laminated on the display screen of the display unit 16, and inputs a variety of information in response to instruction operations by the user. The input unit 17 includes a capacitive touch panel 31a and a resistive touch panel 31b, as will be explained while referencing FIG. 3 described later.

The image-capturing unit 18 captures an image of a subject, and provides data of images including a figure of the subject (hereinafter referred to as “captured image”) to the CPU 11.

The storage unit 19 is configured by a hard disk, DRAM (Dynamic Random Access Memory), or the like, and in addition to data of the various images and data of captured images, stores various programs and the like such as application programs for character recognition.

The communication unit 20 controls communication carried out with another device (not illustrated) through a network including the Internet.

Removable media 41 constituted from magnetic disks, optical disks, magneto-optical disks, semiconductor memory, or the like are installed in the drive 21 as appropriate. Programs (e.g., the aforementioned application programs for character recognition and the like) read from the removable media 41 by the drive 21 are installed in the storage unit 19 as necessary. Similarly to the storage unit 19, the removable media 41 can also store a variety of data such as the data of images stored in the storage unit 19.

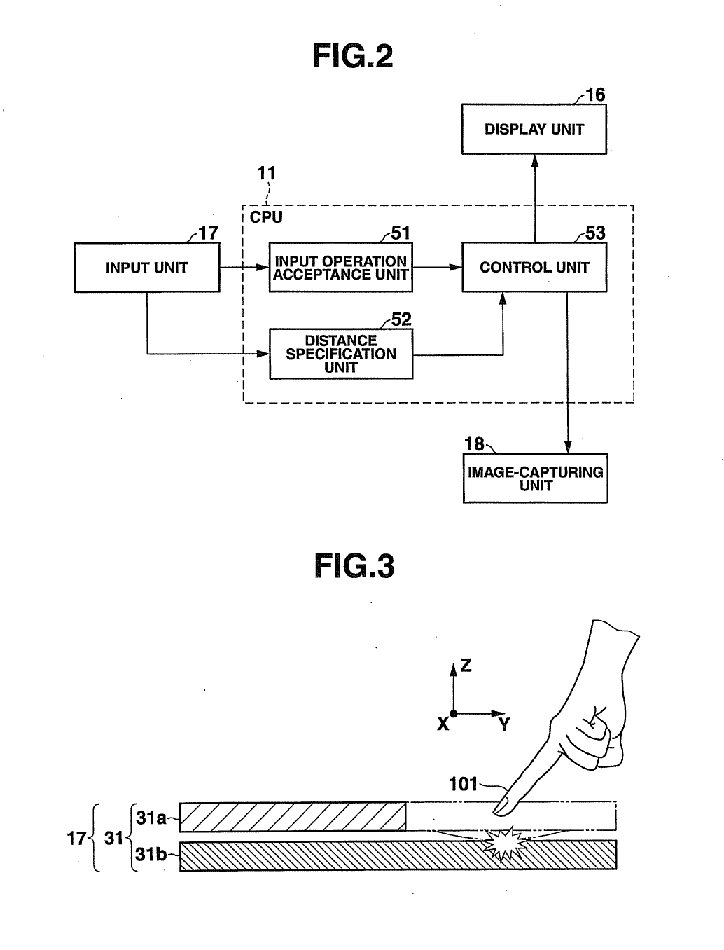

FIG. 2 is a functional block diagram showing, among the functional configurations of such an information processing device 1, the functional configuration for executing input operation acceptance processing.

Input operation acceptance processing refers to the following such processing initiated on the condition of a power button that is not illustrated being depressed by the user. More specifically, input operation acceptance processing refers to a sequence of processing from accepting a touch operation on the touch panel 31 of the input unit 17, until executing processing related to the object in response to this touch operation.

An input operation acceptance unit 51, distance specifying unit 52, and control unit 53 in the CPU 11 function when the execution of the input operation acceptation processing is controlled.

In the present embodiment, a part of the input unit 17 is configured as the capacitive touch panel 31a and the resistive touch panel 31b, as shown in FIG. 3. Hereinafter, in a case where it is not necessary to independently distinguish between the capacitive touch panel 31a and the resistive touch panel 31b, these will be collectively referred to as “touch panel 31”.

FIG. 3 is a cross-sectional view showing a part of the input unit 17.

The capacitive touch panel 31a and resistive touch panel 31b are laminated on the entirety of the display screen of the display of the display unit 16 (refer to FIG. 1), and detect the coordinates of a position at which a touch operation is made. Herein, touch operation refers to an operation of contact or near contact of a body (finger of user, touch pen, etc.) to the touch panel 31, as mentioned in the foregoing.

The capacitive touch panel 31a and the resistive touch panel 31b provide the coordinates of the detected position to the control unit 53 via the input operation acceptance unit 51.

The capacitive touch panel 31a is configured by a conductive film on the display screen of the display of the display unit 16. More specifically, since capacitive coupling occurs from simply a finger tip approaching the surface of the capacitive touch panel 31a, even in a case of the finger tip not contacting the capacitive touch panel 31a, the capacitive touch panel 31a detects the position by capturing the change in capacitance between the finger tip and the conductive film from only nearly contacting. When the user performs an operation (touch operation) to cause a protruding object such as a finger or stylus pen to contact or nearly contact the display screen, the CPU 11 detects the coordinates of the contact point of the finger based on such a change in capacitance between the finger tip and conductive film.

The resistive touch panel 31b is formed by a soft surface film such as of PET (Polyethylene Terephthalate) and a liquid crystal glass film that is on an interior side being overlapped in parallel on the display screen of the display of the display unit 16. Both films have transparent conductive films affixed thereto, respectively, and are electrically insulated from each other through a transparent spacer. The surface film and glass film each have a conductor passing therethrough, and when a user performs a touch operation, the surface film bends due to the stress from the protruding object, and the surface film and glass film partially enter a conductive state. At this time, the electrical resistance value and electrical potential change in accordance with the contact position of the protruding object. The CPU 11 detects the coordinates of the contact point of this protruding object based on such changes in electrical resistance value and electrical potential.

Summarizing the above, the capacitive touch panel 31a detects the position on a two-dimensional plane (on the screen) by capturing the change in capacitance between the finger tip and conductive film.

Herein, the X axis and the Y axis that is orthogonal to the X axis are arranged on this two-dimensional plane (screen), and the Z axis orthogonal to the X and Y axes, i.e. Z axis parallel to a normal vector to the screen, is arranged. In this case, the two-dimensional plane (screen) can be referred to as the “XY plane”.

More specifically, the capacitive touch panel 31a can detect the coordinates (i.e. X coordinate and Y coordinate on the XY plane) of a position on the two-dimensional plane at which a touch operation is made, even with a finger 101 in a noncontact state relative to the capacitive touch panel 31a, i.e. near contact state. Furthermore, in this case, the capacitive touch panel 31a can detect the distance between the finger 101 and the capacitive touch panel 31a, in order words, the coordinate of the position of the finger 101 in a height direction (i.e. Z coordinate on the Z axis), though not at high precision.

In contrast, the resistive touch panel 31b does not detect if a touch operation has been made with the finger 101 in a noncontact state relative to the resistive touch panel 31b. More specifically, in a case of the finger 101 being in a noncontact state relative to the resistive touch panel 31b, the coordinates of the position of the finger 101 on the two-dimensional plane (i.e. X coordinate and Y coordinate on the XY plane) are not detected, and the coordinate (distance) of the position of the finger 101 in the height direction (i.e. Z coordinate on the Z axis) is also not detected. However, the resistive touch panel 31b can detect the coordinates of the position on the two-dimensional plane at which a touch operation is made with high precision and high resolution, compared to the capacitive touch panel 31a.

In the present embodiment, the capacitive touch panel 31a and resistive touch panel 31b are laminated in this order on the entirety of the display screen of the display of the display unit 16; therefore, the resistive touch panel 31b can be protected by the surface of the capacitive touch panel 31a. Furthermore, the coordinates of the position at which a touch operation is made in a noncontact state on the two-dimensional plane, and the distance between the finger 101 and the capacitive touch panel 31a (coordinate of the position in the height direction), i.e. coordinates of the position in three-dimensional space, can be detected by way of the capacitive touch panel 31a. On the other hand, in a case of the finger 101 making contact, the coordinates of the position at which the touch operation is made can be detected with high precision and high resolution by way of the resistive touch panel 31b.

Referring back to FIG. 2, the input operation acceptance unit 51 accepts a touch operation to the touch panel 31 (capacitive touch panel 31a and resistive touch panel 31b) of the input unit 17 as one of the input operations (instruction operation) to the input unit 17. The input operation acceptance unit 51 notifies the control unit 53 of the accepted coordinates of the position on the two-dimensional plane. In addition, when the finger 101 is moved on the screen (XY plane) while a touch operation continues (such a touch operation accompanying movement of the finger 101 on the screen is hereinafter referred to as “flick operation”), the input operation acceptance unit 51 successively notifies the control unit 53 of the coordinates of the position on the XY plane of each position of the finger 101 temporally separated and detected multiple times.

The distance specification unit 52 detects a distance to a body (finger 101, etc.) making the touch operation relative to the capacitive touch panel 31a of the touch panel 31 of the input unit 17. More specifically, the distance specification unit 52 specifies a distance of the finger 101 in a normal vector direction from the capacitive touch panel 31a (display unit 16) by capturing the change in capacitance of the capacitive touch panel 31a, i.e. distance (coordinate of the position in the height direction) between the input unit 17 and the body (hand, finger 101, etc.), and notifies this distance to the control unit 53.

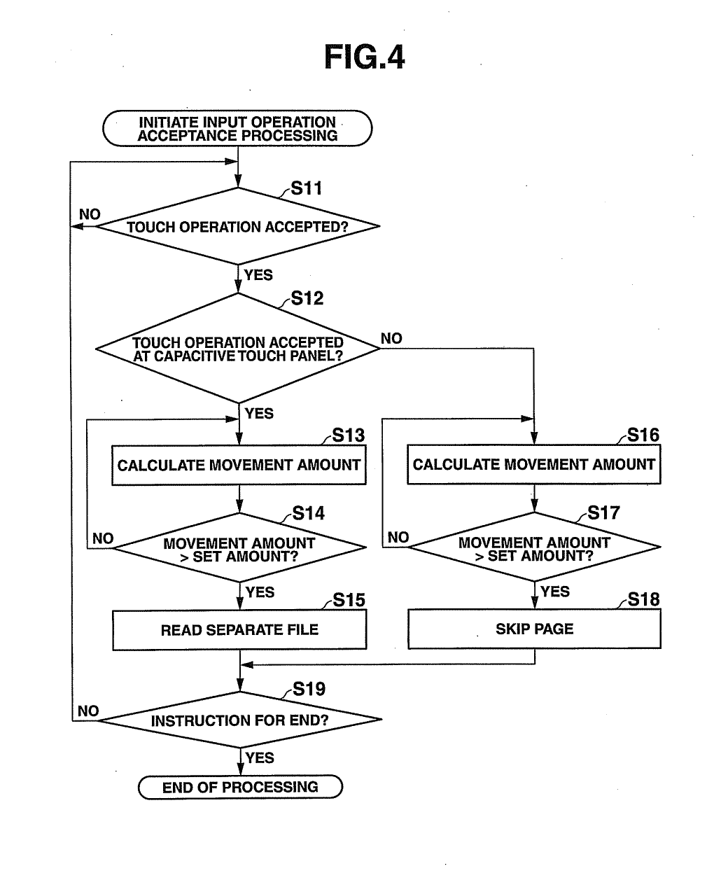

The control unit 53 executes processing related to the object and the like displayed on the display unit 16, based on a movement operation in the two-dimensional directions substantially parallel to the capacitive touch panel 31a (display unit 16) accepted by the input operation acceptance unit 51, i.e. coordinates of the position on the two-dimensional plane of the capacitive touch panel 31a (display unit 16) and the distance (coordinate of the position in the height direction) specified by the distance specification unit 52. More specifically, based on the movement operation accepted by the input operation acceptance unit 51 and the distance specified by the distance specification unit 52, the control unit 53 recognizes an executed touch operation among the various types of touch operations, and executes control to display an image showing a predetermined object corresponding to this touch operation so as to be included on the display screen of the display unit 16. A specific example of an operation related to an object will be explained while referencing FIGS. 4 to 21 described later.

In addition, the control unit 53 can detect an act whereby contact or near contact of a body (finger of the user, touch pen, etc.) to the input unit 17 is initiated (hereinafter referred to as “touch-down”), and an act whereby contact or near contact of the body (finger of the user, touch pen, etc.) is released from the state of touch-down (hereinafter referred to as “touch-up”). More specifically, one touch operation is initiated by way of touch-down, and this one touch operation ends by way of touch-up.

Next, input operation acceptance processing of the first embodiment executed by such an information processing device 1 of the functional configuration of FIG. 2 will be explained while referencing FIG. 4. In the first embodiment, depending on whether or not the user has made a touch operation to the capacitive touch panel 31a, any processing among loading of difference files and page ejection is performed as control on the object.

FIG. 4 is a flowchart illustrating the flow of input operation acceptance processing of the first embodiment executed by the information processing device 1 of the FIG. 1 having the functional configuration of FIG. 2.

When the input operation acceptance processing is executed by the information processing device 1, each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing of each of the following steps will be provided, with each functional block functioning in the CPU 11 as the executor.

The input operation acceptance processing is initiated on the condition of a power button (not illustrated) of the information processing device 1 having been depressed by the user, upon which the following such processing is repeatedly executed.

In Step S11, the input operation acceptance unit 51 determines whether or not a touch operation by the user to the touch panel 31 has been accepted. In a case of a touch operation by the user to the touch panel 31 not having been performed, it is determined as NO in Step S11, and the processing is returned back to Step S11. More specifically, in a period until a touch operation is performed, the determination processing of Step S11 is repeatedly executed, and the input operation acceptance processing enters a standby state. Subsequently, in a case of a touch operation having been performed, it is determined as YES in Step S11, and the processing advances to Step S12.

In Step S12, the distance specification unit 52 determines whether or not a touch operation has been accepted at the capacitive touch panel 31a. More specifically, the distance specification unit 52 determines whether or not an instruction operation related to an object has been accepted at the capacitive touch panel 31a, by specifying the distance (coordinate of the position in the height direction) between the touch panel 31 of the input unit 17 and a body such as a hand, finger, etc. opposing this touch panel 31. In a case of a touch operation having been accepted at the capacitive touch panel 31a, it is determined as YES in Step S12, and the processing advances to Step S13.

In Step S13, the control unit 53 determines that a touch operation to the capacitive touch panel 31a has been made, and calculates a movement amount of the touch operation on the capacitive touch panel 31a. More specifically, the control unit 53 calculates the movement amount of a current touch operation based on the difference of the coordinates of a position in two-dimensions when initiating touch operation acceptance that was accepted through the input operation acceptance unit 51, and the coordinates of a position in two-dimensions during current touch operation acceptance.

In Step S14, the control unit 53 determines whether or not a movement amount calculated in Step S13 exceeds a setting amount set in advance. In a case of the movement amount not exceeding the setting amount, it is determined as NO in Step S14, and the processing returns to Step S13. More specifically, in a period until the movement amount exceeds the setting amount, the input operation acceptance processing enters a standby state. In a case of the movement amount exceeding the setting amount, it is determined as YES in Step S14, and the processing advances to Step S15.

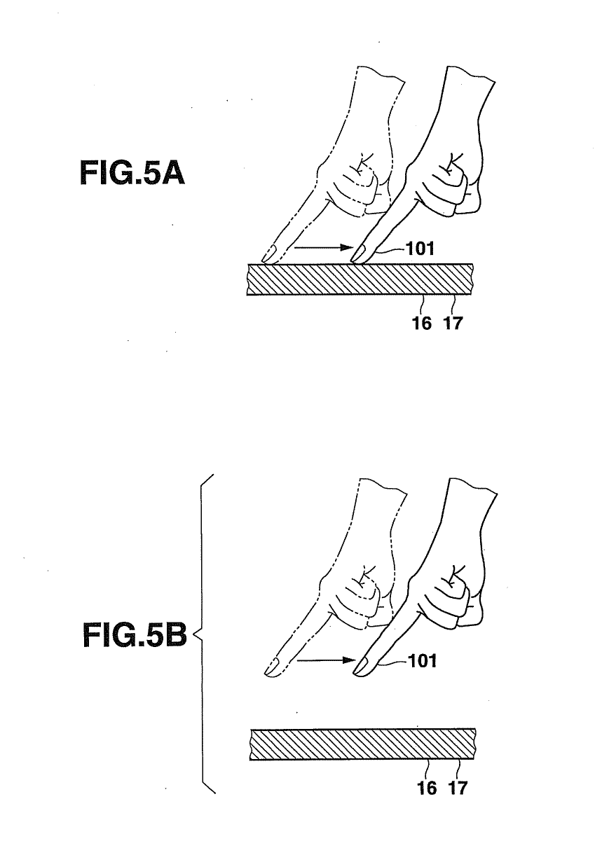

In Step S15, the control unit 53 performs reading of a separate file. A specific example of the reading of a separate file will be explained while referencing FIGS. 5A and 5B described later. When this processing ends, the processing advances to Step S19. The processing from Step S19 and after will be described later.

In a case of a touch operation not having been accepted at the capacitive touch panel 31a, it is determined as NO in Step S12, and the processing advances to Step S16.

In Step S16, the control unit 53 determines that a touch operation has been made on the resistive touch panel 31b, and calculates the movement amount of the touch operation on the resistive touch panel 31b. More specifically, the control unit 53 calculates the movement amount of a current touch operation based on the difference of the coordinates of a position in two-dimensions when initiating touch operation acceptance that was accepted through the input operation acceptance unit 51, and the coordinates of a position in two-dimensions during current touch operation acceptance.

In Step S17, the control unit 53 determines whether or not the movement amount calculated in Step S16 exceeds a setting amount set in advance. In a case of the movement amount not exceeding the setting amount, it is determined as NO in Step S17, and the processing returns to Step S16. More specifically, in a period until the movement amount exceeds the setting amount, the input operation acceptance processing enters a standby state. In a case of the movement amount exceeding the setting amount, it is determined as YES in Step S17, and the processing advances to Step S18.

In Step S18, the control unit 53 performs page skip. A specific example of page skip will be explained while referencing FIGS. 5A and 5B described later. When this processing ends, the processing advances to Step S19.

In Step S19, the control unit 53 determines whether or not there is an instruction of input operation acceptance end. In a case of there not being an instruction of input operation acceptance end, it is determined as NO in Step S19, and the processing is returned to Step S11. More specifically, in a period until there is an instruction of input operation acceptance end, the processing of Steps S11 to S19 is repeatedly performed.

By configuring in this way, it is possible to control a desired object in reading a separate file or page skip, by repeating a touch operation on the touch panel 31, in a period until the user performs an instruction of input operation acceptance end. Subsequently, in a case of an instruction of input operation acceptance end being made by the user performing a predetermined operation to the information processing device 1, for example, it is determined as YES in Step S19, and the input operation acceptance processing comes to an end.

Next, a specific example of processing related to an object in accordance with an operation to the input unit 17 will be explained. Herein, an example of changing the processing related to an object depending on a difference in the distance between the finger 101 and the input unit 17, even in a case of making a flick operation, will be explained.

FIGS. 5A and 5B are views showing states in which a flick operation is made on the input unit 17 of the information processing device of FIG. 1.

As shown in FIG. 5A, in a case of the user making a flick operation with the distance between the input unit 17 and the finger 101 being 0, i.e. in a case of making a flick operation by maintaining a state contacting the finger 101 to the input unit 17, the control unit 53 determines that a touch operation has been accepted at the resistive touch panel 31b, and executes first processing as the processing related to the object.

In contrast, as shown in FIG. 5B, in a case of the user making a flick operation in a state of the distance between the input unit 17 and the finger 101 being far, i.e. in a case of making a flick operation by maintaining a state in which the finger 101 is in noncontact relative to the input unit 17, the control unit 53 determines that a touch operation has been accepted at the capacitive touch panel 31a, and executes second processing as the processing related to the object.

Herein, the first processing and second processing may be any processing so long as being different processing from each other; however, in the present embodiment, processing to read a file (one type of object) to be displayed on the display unit 16 from the storage unit 19, and display the new file thus read on the display unit 16 is adopted as the first processing. In addition, processing to skip a page of a book or notes (another type of object) being displayed on the display unit 16 is adopted as the second processing.

More specifically, in a case of the user making a flick operation with the distance between the input unit 17 and the finger 101 being 0 (case of FIG. 5A), the control unit 53 skips a page of a book or notes (one type of object) being displayed on the display unit 16, and displays the next page on the display unit 16. In contrast, in a case of the user making a flick operation in a state of the distance between the input unit 17 and the finger 101 being far (case of FIG. 5B), the control unit 53 reads a file to be displayed on the display unit 16 from the storage unit 19, and displays the new file thus read on the display unit 16.

The information processing device 1 according to the first embodiment of the present invention has been explained in the foregoing. Next, an information processing device 1 according to a second embodiment of the present invention will be explained.

### Second Embodiment

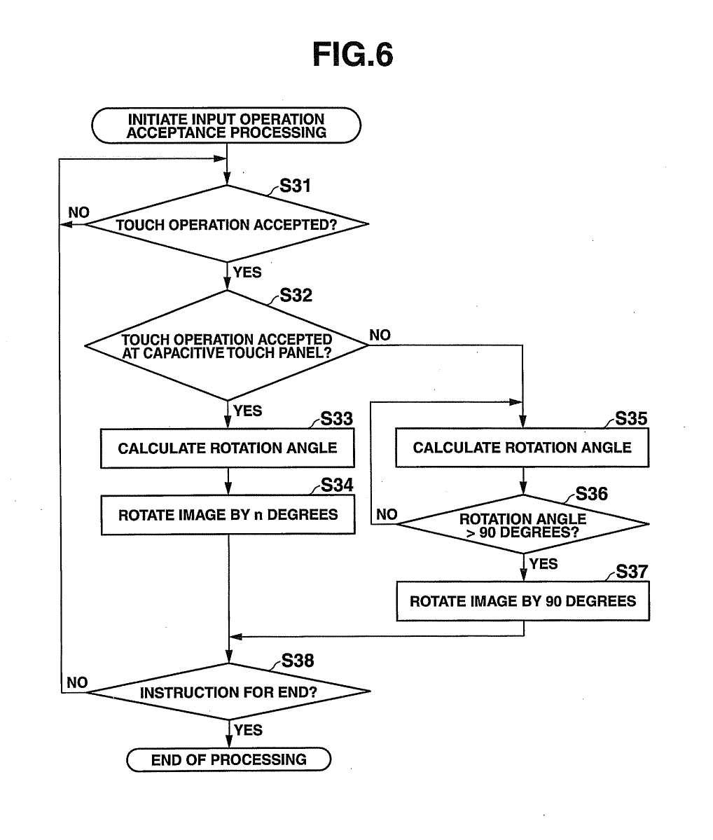

Next, input operation acceptance processing of the second embodiment executed by the information processing device 1 of the functional configuration of FIG. 2 will be explained while referencing FIG. 6. In the second embodiment, any processing among rotating the angle of an image being displayed on the display unit 16 to any angle about the contact point of the touch operation, and rotating to a specified broad angle (e.g., 90°) is performed as the control related to the object, depending on whether or not the user makes a touch operation to the capacitive touch panel 31a.

When input operation acceptance processing of the second embodiment is executed by the information processing device 1, each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing in each of the following steps will be provided with each functional block functioning in the CPU 11 as the executor.

FIG. 6 is a flowchart illustrating the flow of input operation acceptance processing of the second embodiment executed by the information processing device 1 of FIG. 1 having the functional configuration of FIG. 2.

The input operation acceptance processing is initiated on the condition of a power button (not illustrated) of the information processing device 1 having been depressed by the user, upon which the following such processing is repeatedly executed.

In Step S31, the input operation acceptance unit 51 determines whether or not a touch operation by the user to the touch panel 31 has been accepted. In a case of a touch operation by the user to the touch panel 31 not having been performed, it is determined as NO in Step S31, and the processing is returned back to Step S31. More specifically, in a period until a touch operation is performed, the determination processing of Step S31 is repeatedly executed, and the input operation acceptance processing enters a standby state. Subsequently, in a case of a touch operation having been performed, it is determined as YES in Step S31, and the processing advances to Step S32.

In Step S32, the distance specification unit 52 determines whether or not a touch operation has been accepted at the capacitive touch panel 31a. More specifically, the distance specification unit 52 determines whether or not an instruction operation related to an object has been accepted at the capacitive touch panel 31a, by specifying the distance (i.e. Z coordinate on Z axis) between the touch panel 31 of the input unit 17 and a body such as a hand, finger, etc. opposing this touch panel 31. In a case of a touch operation having been accepted at the capacitive touch panel 31a, it is determined as YES in Step S32, and the processing advances to Step S33.

In Step S33, the control unit 53 determines that a touch operation to the capacitive touch panel 31a has been made, and calculates a rotation angle of the touch operation on the capacitive touch panel 31a. More specifically, the control unit 53 calculates the rotation angle of a current touch operation based on the difference in angles of the angle of coordinates of a position in two-dimensions when initiating touch operation acceptance that was accepted through the input operation acceptance unit 51, and the angle of the coordinates of a position in two-dimensions during current touch operation acceptance.

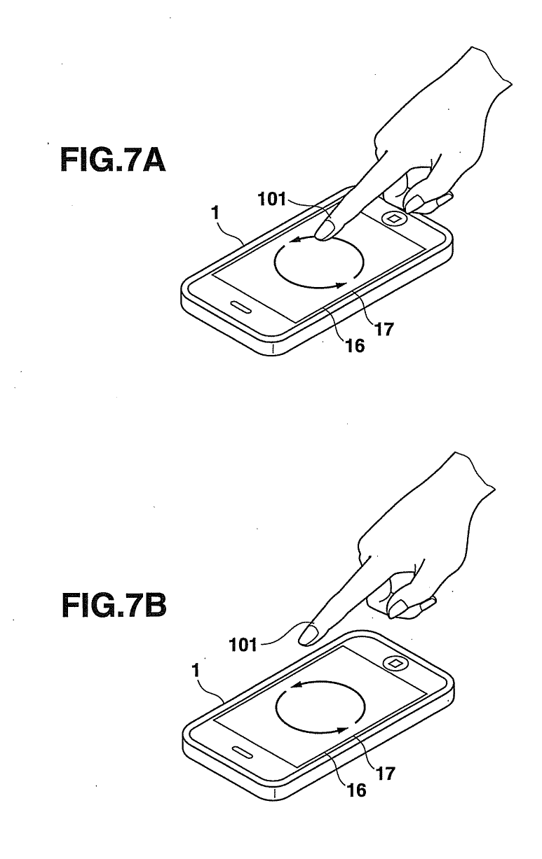

In Step S34, the control unit 53 performs control to display an image being displayed on the display unit 16 to be rotated by n degrees (n is any angle of 0 to 360°). A specific example of rotation of an image will be explained while referencing FIGS. 7A and 7B described later. When this processing ends, the processing advances to Step S38. The processing from Step S38 and after will be described later.

In a case of a touch operation not having been accepted at the capacitive touch panel 31a, it is determined as NO in Step S32, and the processing advances to Step S35.

In Step S35, the control unit 53 determines that a touch operation has been made on the resistive touch panel 31b, and calculates the rotation angle of the touch operation on the resistive touch panel 31b. More specifically, the control unit 53 calculates the rotation angle of a current touch operation based on the difference in angles of the angle of coordinates of a position in two-dimensions when initiating touch operation acceptance that was accepted through the input operation acceptance unit 51, and the angle of the coordinates of a position in two-dimensions during current touch operation acceptance.

In Step S36, the control unit 53 determines whether or not the rotation angle calculated in Step S35 exceeds 90°. In a case of the rotation angle not exceeding 90°, it is determined as NO in Step S36, and the processing returns to Step S35. More specifically, in a period until the rotation angle exceeds 90°, the input operation acceptance processing enters a standby state. In a case of the rotation angle exceeding 90°, it is determined as YES in Step S36, and the processing advances to Step S37. It should be noted that, although the control unit 53 determines whether or not the rotation angle calculated exceeds 90°, the determining rotation angle is not limited to 90°, and any angle (0 to 360°) set in advance by the user can be employed.

In Step S37, the control unit 53 performs control to display an image being displayed on the display unit 16 to be rotated by 90°. A specific example of rotating an image by 90° will be explained while referencing FIGS. 7A and 7B described later. When this processing ends, the processing advances to Step S38.

In Step S38, the control unit 53 determines whether or not there is an instruction for input operation acceptance end. In a case of there not being an instruction for input operation acceptance end, it is determined as NO in Step S38, and the processing is returned to Step S31. More specifically, in a period until there is an instruction for input operation acceptance end, the processing of Steps S31 to S38 is repeatedly performed.

By configuring in this way, it is possible to control to display an image (object) being displayed on the display unit 16 to be rotated by an arbitrary angle (n degrees), or to display the image (object) to be rotated to an angle set in advance (90° in the present embodiment), by repeating a touch operation on the touch panel 31, in a period until the user performs an instruction of input operation acceptance end. Subsequently, in a case of an instruction of input operation acceptance end being made by the user performing a predetermined operation to the information processing device 1, for example, it is determined as YES in Step S38, and the input operation acceptance processing comes to an end.

Next, a specific example of processing related to an object in accordance with an operation to the input unit 17 will be explained.

An example of changing the processing related to an object depending on a difference in the distance between the finger 101 and the input unit 17, even in a case of making a flick operation such as that to make a circle on the display screen (two-dimensional plane) of the display unit 16, will be explained.

FIGS. 7A and 7B are views showing states in which a flick operation is made such as that to make a circle on the input unit 17 of the information processing device in FIG. 1.

As shown in FIG. 7A, in a case of the user making a flick operation such as that to make a circle with the distance between the input unit 17 and the finger 101 being 0, i.e. in a case of making a flick operation by maintaining a state contacting the finger 101 to the input unit 17, the control unit 53 determines that a touch operation has been accepted at the resistive touch panel 31b, and executes third processing as the processing related to the object.

In contrast, as shown in FIG. 7B, in a case of the user making a flick operation such as that to make a circle in a state of the distance between the input unit 17 and the finger 101 being far, i.e. in a case of making a flick operation by maintaining a state in which the finger 101 is in noncontact relative to the input unit 17, the control unit 53 determines that a touch operation has been accepted at the capacitive touch panel 31a, and executes fourth processing as the processing related to the object.

In the present embodiment, processing to display an image (type of object) displayed on the display unit 16 to be rotated to an arbitrary angle (n degrees) is adopted as the third processing. In addition, processing to display an image (another type of object) being displayed on the display unit 16 to be rotated by 90° (arbitrary angle set in advance by the user) is adopted as the fourth processing.

More specifically, in a case of the user making a flick operation such as that to make a circle with the distance between the input unit 17 and the finger 101 being 0 (case of FIG. 7A), the control unit 53 displays, on the display unit 16, an image being displayed on the display unit 16 to be rotated 90° (broad angle set in advance by the user). In contrast, in a case of the user making a flick operation such as that to make a circle in a state of the distance between the input unit 17 and the finger 101 being far (case of FIG. 7B), the control unit 53 displays, on the display unit 16, an image being displayed on the display unit 16 to be rotated to an arbitrary angle (n degrees) smoothly about a contact point of the touch operation.

The information processing device 1 according to the second embodiment of the present invention has been explained in the foregoing.

Next, an information processing device 1 according to a third embodiment of the present invention will be explained.

### Third Embodiment

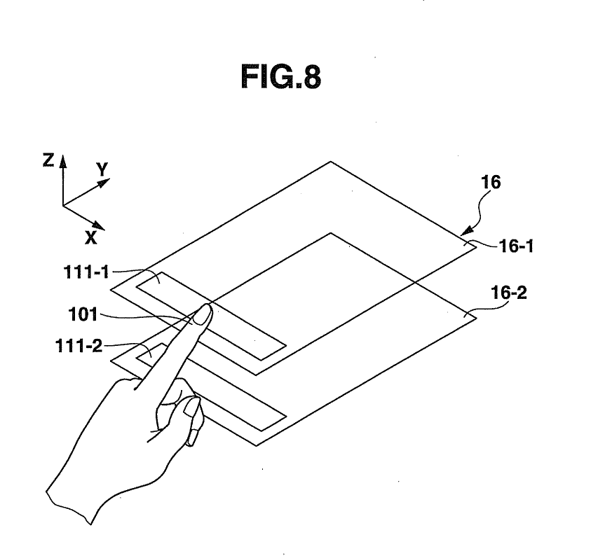

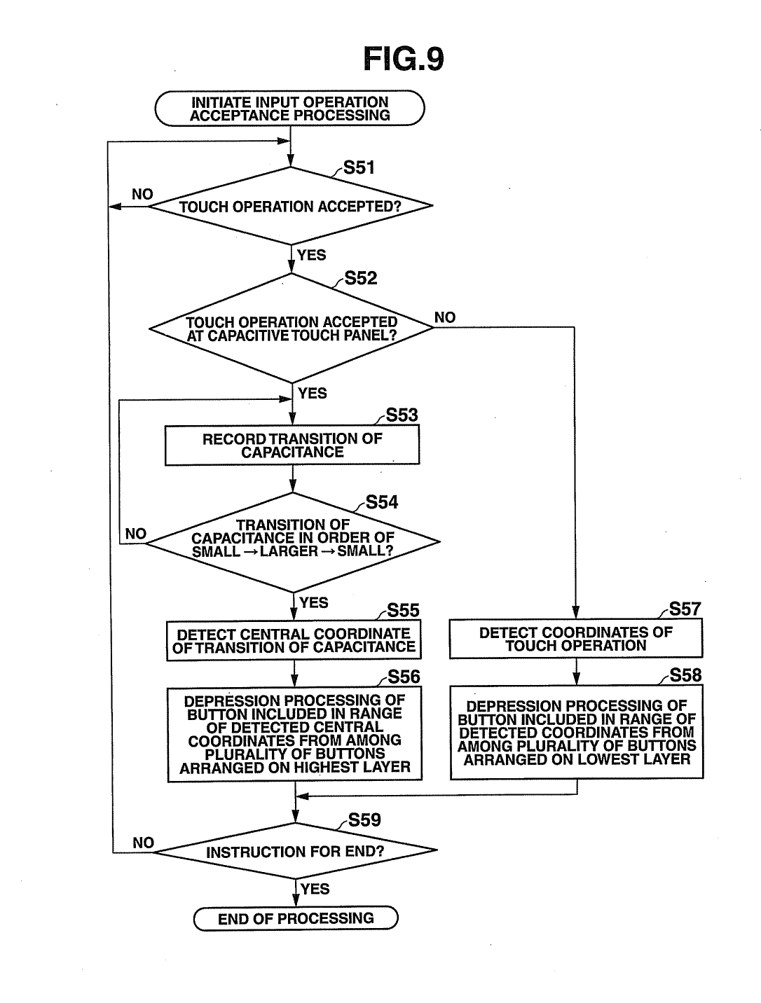

Next, input operation acceptance processing of the third embodiment executed by the information processing device 1 of the functional configuration of FIG. 2 will be explained while referencing FIGS. 8 and 9.

In the third embodiment, software buttons (hereinafter referred to simply as “buttons”) are employed as the objects displayed on the display unit 16. More specifically, a predetermined 3D image is displayed on the display unit 16 so as to project to the eyes of the user when a plurality of buttons are scattered on a plurality of layers being displayed in the three-dimensional space constructed over the screen of the display unit 16. In other words, among the plurality of buttons, there are buttons arranged in layers on the screen, and there are buttons arranged in a layer floating in the air above the screen as well. The user can make a touch operation so as to depress a desired button among the buttons of the plurality of layers scattered within these spaces.

In this case, the information processing device 1 executes processing (hereinafter referred to as “depress processing”) for detecting depression of this button as a touch operation to the capacitive touch panel 31a, and causes the function assigned to this button to be exhibited.

When input operation acceptance processing of the third embodiment is executed by the information processing device each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing of each of the following steps will be provided, with each functional block functioning in the CPU 11 as the executor.

FIG. 8 is a view illustrating a display example that is displayed by the display unit 16 of the information processing device 1 of FIG. 1 having the functional configuration of FIG. 2.

The display unit 16 of the third embodiment is configured to enable a 3D (three-dimensional) image (not illustrated) to be displayed.

The 3D image displayed on the display unit 16 is configured so as to project to the eyes of the user by the plurality of layers piling up in the Z-axis direction (height direction). Herein, the lowest layer in the 3D image is a layer at the same position as the resistive touch panel 31b, and higher layers other than this lowest layer project to the eyes of the users so as to float in space, and become higher as the arrangement position rises (as approaching the eyes of the user in the Z axis direction).

However, for simplification of the explanation, the 3D image is configured herein from only a highest layer 16-1 and a lowest layer 16-2, as shown in FIG. 8. In other words, the 3D image is configured from only the near layer 16-1 and the layer 16-2 in back thereof, when viewed from the user having the finger 101. Then, a 3D image projects to the eyes of the viewing user so that a button 111-1 is arranged in the highest layer 16-1, and a button 111-2 is arranged in the lowest layer 16-2. In other words, the button 111-1 and button 111-2 are arranged at substantially the same coordinates (x, y) as each other, and only the coordinate z differs. Herein, the coordinate x is the X-axis coordinate, the coordinate y is the Y-axis coordinate, and the coordinate z is the Z-axis coordinate.

A touch operation to the highest layer 16-1 can be detected based on the electrical potential change in capacitance on the capacitive touch panel 31a. In addition, a touch operation to the lowest layer 16-2 can be detected based on the presence of contact to the resistive touch panel 31b.

It should be noted that, although the relationship between the highest layer 16-1 and lowest layer 16-2 is explained in the present embodiment, it is not limited thereto. For example, the capacitive touch panel 31a is able to detect the coordinate z; therefore, in a case of a plurality of layers other than the lowest layer existing, it is possible to detect the layer on which a touch operation was made according to the coordinate z detected.

Next, input operation acceptance processing of the third embodiment executed by the information processing device 1 of the functional configuration in FIG. 2 will be explained while referencing FIG. 9.

FIG. 9 is a flowchart illustrating the flow of input operation acceptance processing of the third embodiment executed by the information processing device 1 of FIG. 1 having the functional configuration of FIG. 2.

The input operation acceptance processing is initiated on the condition of a power button of the information processing device 1 being depressed by the user, and the following such processing is repeatedly executed.

In Step S51, the input operation acceptance unit 51 determines whether or not a touch operation by the user to the touch panel 31 has been accepted. In a case of a touch operation by the user to the touch panel 31 not having been performed, it is determined as NO in Step S51, and the processing is returned back to Step S51. More specifically, in a period until a touch operation is performed, the determination processing of Step S51 is repeatedly executed, and the input operation acceptance processing enters a standby state. Subsequently, in a case of a touch operation having been performed, it is determined as YES in Step S51, and the processing advances to Step S52.

In Step S52, the distance specification unit 52 determines whether or not a touch operation has been accepted at the capacitive touch panel 31a. More specifically, the distance specification unit 52 determines whether or not an instruction operation related to an object has been accepted at the capacitive touch panel 31a, by specifying the distance (coordinate of the position in the height direction) between the touch panel 31 of the input unit 17 and a body such as a hand, finger, etc. opposing this touch panel 31. In a case of a touch operation having been accepted at the capacitive touch panel 31a, it is determined as YES in Step S52, and the processing advances to Step S53.

In Step S53, the control unit 53 determines that a touch operation to the capacitive touch panel 31a has been made, and records a change in capacitance between the finger 101 and the capacitive touch panel 31a. More specifically, the control unit 53 initiates recording of the electrical potential change in the capacitance (hereinafter simply referred to as “capacitance”) of a capacitor (not illustrated) provided to the capacitive touch panel 31a.

In Step S54, the control unit 53 determines whether or not the transition of capacitance for which recording was initiated in Step S53 changes in the order of “small-to-large-to-small”.

Herein, when the finger 101 is made to approach the capacitive touch panel 31a, the capacitance slightly increases. At this time, the capacitance is still in the “small” state. Subsequently, when the finger 101 is made to further approach the capacitive touch panel 31a and the finger 101 almost contacts the capacitive touch panel 31a, the capacitance reaches a maximum. At this time, the capacitance enters the “large” state. Subsequently, as the almost contact of the finger 101 to the capacitive touch panel 31a is released, and the finger 101 moves so as to become distant upwards (Z-axis direction), the capacitance gradually decreases. At this time, the capacitance gradually enters the “small” state.

The actions in the sequence of the user beginning to bring their finger 101 towards the capacitive touch panel 31a, causing to almost contact the capacitive touch panel 31a, until subsequently becoming distant is hereinafter referred to as “tap operation”. In other words, the tap operation refers to the actions in a sequence from one touch operation initiated by beginning to bring the finger 101 towards the capacitive touch panel 31a, until subsequently ending this one touch operation by making the finger 101 distant.

The control unit 53 can detect whether or not a tap operation has been made depending on whether or not the transition in capacitance changes in the order of “small” to “large” to “small”.

In Step S55, the control unit 53 detects a central coordinate of the transition in capacitance recorded in the processing of Step S54. Herein, although an example in which one button is arranged on one layer is illustrated in FIG. 8, a plurality of buttons is actually arranged on one layer. The control unit 53 detects an average value of each coordinate at positions in two dimensions as the central coordinate of transition in capacitance, upon a tap operation being performed. Then, the control unit 53 specifies a button included within a range of the detected central coordinate, from among the plurality of buttons arranged on one layer.

In Step S56, from among the plurality of buttons arranged on the highest layer 16-1 (refer to FIG. 8), the control unit 53 performs depress processing of the button 111-1 included within the range of the central coordinate detected in the processing of Step S55. When this processing ends, the processing advances to Step S59. The processing from Step S59 and after will be described later.

In a case of a touch operation not having been accepted at the capacitive touch panel 31a, it is determined as NO in Step S52, i.e. it is determined that a touch operation is made on the resistive touch panel 31b, and the processing advances to Step S57.

In Step S57, the control unit 53 detects the coordinates at which the touch operation was made on the resistive touch panel 31b. Then, the control unit 53 specifies the button included within the range of the detected coordinates, from among the plurality of buttons arranged on one layer.

In Step S58, from among the plurality of buttons arranged on the lowest layer 16-2 (refer to FIG. 8), the control unit 53 performs depress processing of the button 111-2 included within the range of the coordinates detected in the processing of Step S57.

In Step S59, the control unit 53 determines whether or not there is an instruction for input operation acceptance end. In a case of there not being an instruction for input operation acceptance end, it is determined as NO in Step S59, and the processing is returned to Step S51. In other words, in a period until there is an instruction for input operation acceptance end, the processing of Steps S51 to S59 is repeatedly performed.

By configuring in this way, a touch operation is repeatedly performed by the user in a period until an instruction for input operation acceptance end is performed by the user, whereby control of depress processing on a button corresponding to any layer among the highest layer 16-1 and the lowest layer 16-2 is performed. Subsequently, in a case of an instruction for input operation acceptance end being made by the user performing a predetermined operation on the information processing device 1, for example, it is determined as YES in Step S59, and the input operation acceptance processing comes to an end.

The information processing device 1 according to the third embodiment of the present invention has been explained in the foregoing.

Next, an information processing device 1 according to a fourth embodiment of the present invention will be explained.

### Fourth Embodiment

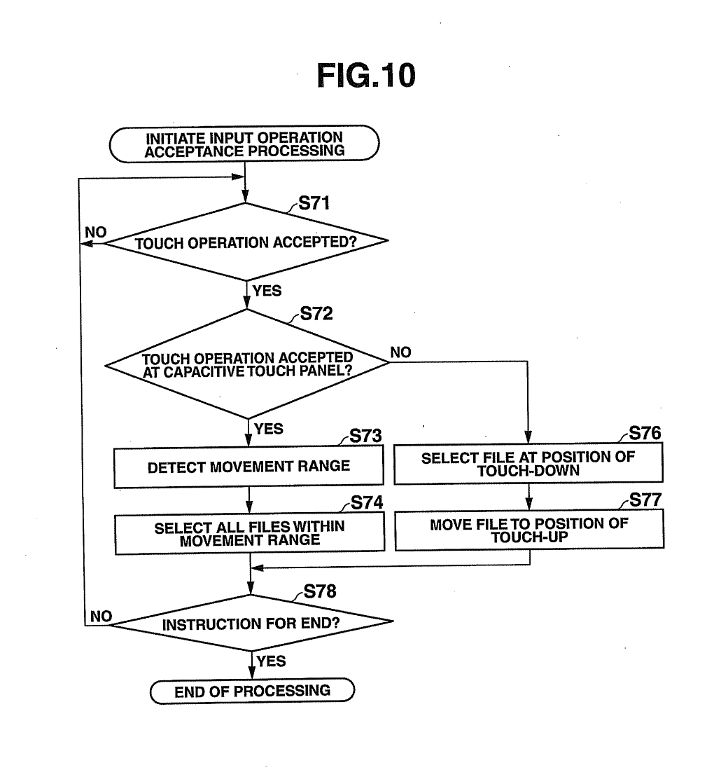

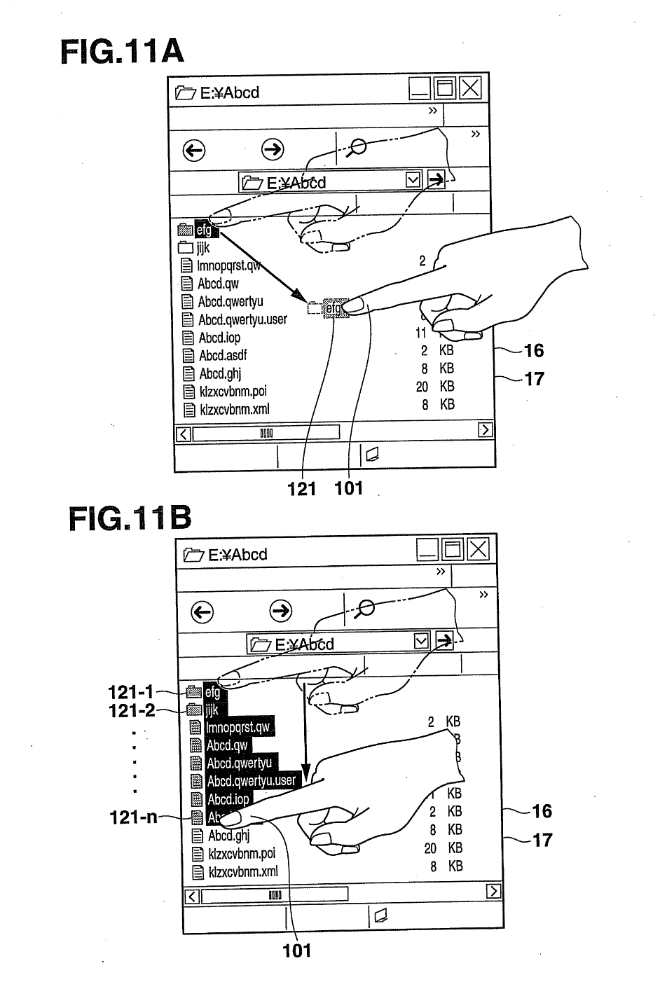

Next, input operation acceptance processing of the fourth embodiment executed by such an information processing device 1 of the functional configuration of FIG. 2 will be explained while referencing FIGS. 10, 11A and 11B. In the fourth embodiment, it is possible to control a file operation of the UI (User Interface) of a PC (Personal Computer) depending on whether or not a user has made a touch operation to the capacitive touch panel 31a. As a specific example of the control of a file (one type of object) operation, either processing is performed among selecting all of the files within a movement range of the touch operation, and moving a file when the touch operation is made. In the fourth embodiment, either processing is performed among selecting all of the files within a movement range and moving a file when the touch operation is made as control of the object, depending on whether or not the user has made a touch operation to the capacitive touch panel 31a. Moving a file indicates moving a file present at a coordinate position upon touch-down being made to a coordinate position upon touch-up being made, i.e. processing of drag-and-drop.

When input operation acceptance processing of the fourth embodiment is executed by the information processing device 1, each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing in each of the following steps will be provided with each functional block functioning in the CPU 11 as the executor.

FIG. 10 is a flowchart illustrating the flow of input operation acceptance processing of the fourth embodiment executed by the information processing device 1 of FIG. 1 having the functional configuration of FIG. 2.

The input operation acceptance processing is initiated on the condition of a power button (not illustrated) of the information processing device 1 having been depressed by the user, upon which the following such processing is repeatedly executed.

In Step S71, the input operation acceptance unit 51 determines whether or not a touch operation by the user to the touch panel 31 has been accepted. In a case of a touch operation by the user to the touch panel 31 not having been performed, it is determined as NO in Step S71, and the processing is returned back to Step S71. More specifically, in a period until a touch operation is performed, the determination processing of Step S71 is repeatedly executed, and the input operation acceptance processing enters a standby state. Subsequently, in a case of a touch operation having been performed, it is determined as YES in Step S71, and the processing advances to Step S72.

In Step S72, the distance specification unit 52 determines whether or not a touch operation has been accepted at the capacitive touch panel 31a. More specifically, the distance specification unit 52 determines whether or not an instruction operation related to an object has been accepted at the capacitive touch panel 31a, by specifying the distance (coordinate of the position in the height direction) between the touch panel 31 of the input unit 17 and a body such as a hand, finger, etc. opposing this touch panel 31. In a case of a touch operation having been accepted at the capacitive touch panel 31a, it is determined as YES in Step S72, and the processing advances to Step S73.

In Step S73, the control unit 53 determines that a touch operation has been made to the capacitive touch panel 31a, and detects a movement range of a finger from the coordinate position at which touch-down was made until the coordinate position at which touch-up was made. More specifically, the control unit 53 detects that a touch operation has been made by the user to the capacitive touch panel 31a, and recognizes the coordinate position of this touch operation. The control unit 53 detects, as the movement range, the range included between the coordinate position when the touch-down was made on the capacitive touch panel 31a to the coordinate position at which touch-up was made.

In Step S74, the control unit 53 selects all of the files within the movement range detected in Step S73. The selection of files within the movement range will be explained while referencing FIGS. 11A and 11B described later. When this processing ends, the processing advances to Step S78. The processing from Step S78 and after will be described later.

In a case of a touch operation not having been accepted at the capacitive touch panel 31a, it is determined as NO in Step S72, and the processing advances to Step S76.

In Step S76, the control unit 53 determines that a touch operation has been made to the resistive touch panel 31b, and selects the file of the coordinate position at which touch-down was made. The selection of files will be explained while referencing FIGS. 11A and 11B described later.

In Step S77, the control unit 53 moves the file selected in Step S76 to the coordinate position at which touch-up is made. The movement of the file will be explained while referencing FIGS. 11A and 11B described later.

In Step S78, the control unit 53 determines whether or not there is an instruction of input operation acceptance end. In a case of there not being an instruction of input operation acceptance end, it is determined as NO in Step S78, and the processing is returned to Step S71. More specifically, in a period until there is an instruction of input operation acceptance end, the processing of Steps S71 to S78 is repeatedly performed.

By configuring in this way, it is possible to control whether to select all of the files (objects) within a movement range, or to move a file of a coordinate position at which touch-down was made to a coordinate position at which touch-up was made (i.e. drag-and-drop), by repeating a touch operation on the touch panel 31, in a period until the user performs an instruction of input operation acceptance end. Subsequently, in a case of an instruction of input operation acceptance end being made by the user performing a predetermined operation to the information processing device 1, for example, it is determined as YES in Step S78, and the input operation acceptance processing comes to an end.

Next, a specific example of processing related to an object in accordance with an operation to the input unit 17 will be explained.

An example of changing the processing related to an object depending on a difference in the distance between the finger 101 and the input unit 17, even in a case of making touch-down and touch-up on the display screen (two-dimensional plane) of the display unit 16, will be explained.

FIGS. 11A and 11B are views showing states in which touch-down and touch-up is made on the input unit 17 of the information processing device of FIG. 1.

As shown in FIG. 11A, in a case of the user making touch-down and touch-up with the distance between the input unit 17 and the finger 101 being 0, i.e. in a case of making a flick operation by maintaining a state contacting the finger 101 to the input unit 17, the control unit 53 determines that a touch operation has been accepted at the resistive touch panel 31b, and executes fifth processing as the processing related to the object.

In contrast, as shown in FIG. 11B, in a case of touch-down and touch-up being made in a state of the distance between the input unit 17 and the finger 101 being far, i.e. in a case of making a flick operation by maintaining a state in which the finger 101 is in noncontact relative to the input unit 17, the control unit 53 determines that a touch operation has been accepted at the capacitive touch panel 31a, and executes sixth processing as the processing related to the object.

In the present embodiment, the processing to select a file that is at the coordinate position of touch-down, and then move the file to the coordinate position of touch-up is adopted as the fifth processing. In addition, the processing to select all of the files within a movement range included from the coordinate position of touch-down to the coordinate position of touch-up is adopted as the sixth processing.

In other words, in a case of the user making touch-down and touch-up with the distance between the input unit 17 and the finger 101 being 0 (case of FIG. 11A), among the files being displayed on the display unit 16, the control unit 53 moves the file (one type of object) of the coordinate position at which touch-down was made to the coordinate position at which touch-up was made. In contrast, in a case of the user making touch-up and touch-down in a state in which the distance between the input unit 17 and the finger 101 is far (case of FIG. 11B), the control unit 53 selects all of the files that are within the movement range among the files being displayed on the display unit 16 (one type of object).

The information processing device 1 according to the fourth embodiment of the present invention has been explained in the foregoing.

Next, an information processing device 1 according to a fifth embodiment of the present invention will be explained.

### Fifth Embodiment

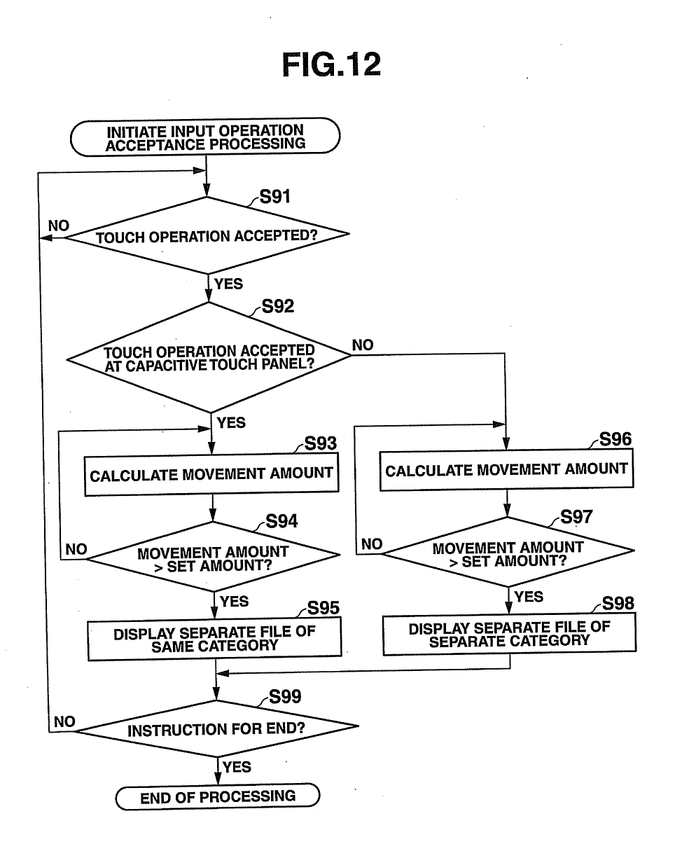

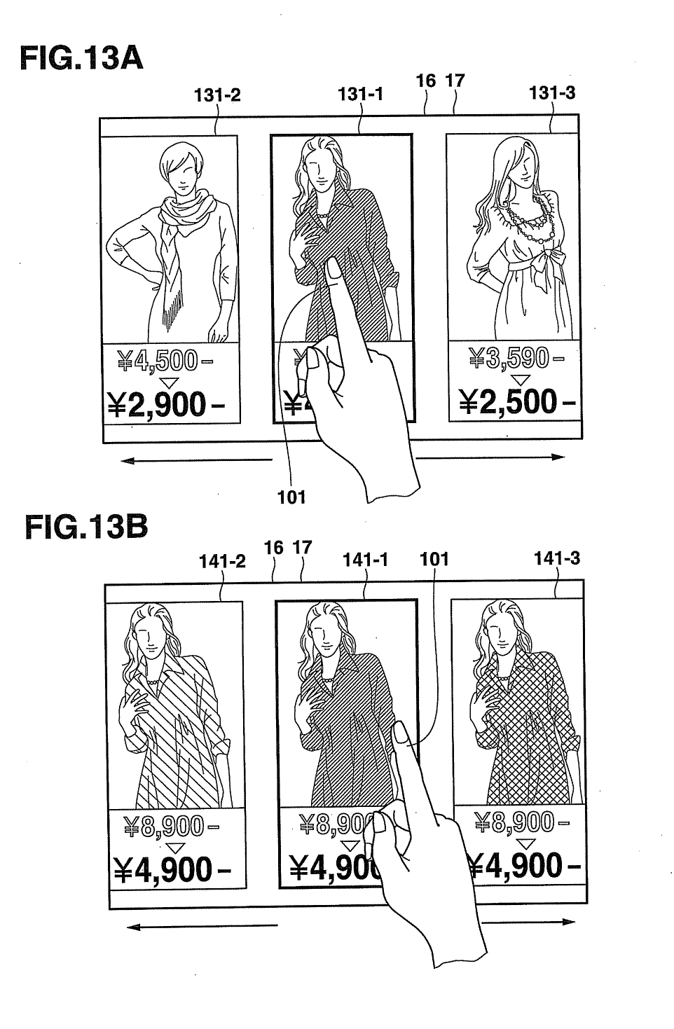

Next, input operation acceptance processing of the fifth embodiment executed by such an information processing device 1 of the functional configuration of FIG. 2 will be explained while referencing FIGS. 12, 13A and 13B.

The information processing device 1 according to the fifth embodiment can adopt basically the same hardware configuration and functional configuration as the information processing device 1 according to the first embodiment.

Therefore, FIG. 1 is also a block diagram showing the hardware configuration of the information processing device 1 according to the fifth embodiment. In addition, FIG. 2 is also a functional block diagram showing the functional configuration of the information processing device 1 according to the fifth embodiment.

Furthermore, the input operation acceptance processing executed by the information processing device 1 according to the fifth embodiment has basically the same flow as the input operation acceptance processing according to the first embodiment.

However, the fifth embodiment differs from the first embodiment in the aspect of either processing is performed to display a separate file of the same category or to display a separate file of a separate category, as the control related to the object, depending on whether or not the user has made a touch operation to the capacitive touch panel 31a.

Therefore, for the processing of Step S15 and Step S18 in the fifth embodiment, rather than the flowchart of FIG. 4 employed in the first embodiment, the flowchart of FIG. 12 is employed. More specifically, in the fifth embodiment, in the input operation acceptance processing of FIG. 4, the processing of Step S95 is performed in place of Step S15, and the processing of Step S98 is performed in place of Step S18.

Therefore, only Step S95 and Step S98, which are the points of difference, will be explained below, and explanations of points in agreement will be omitted as appropriate.

When input operation acceptance processing of the fifth embodiment is executed by the information processing device 1, each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing in each of the following steps will be provided with each functional block functioning in the CPU 11 as the executor.

FIG. 12 is a flowchart illustrating the flow of input operation acceptance processing of the fifth embodiment executed by the information processing device 1 of FIG. 1 having the functional configuration of FIG. 2.

In Step S95, the control unit 53 executes control to display a separate file of the same category. A specific example of displaying a separate file of the same category will be explained while referencing FIGS. 13A and 13B described later. When this processing ends, the processing advances to Step S99.

In Step S98, the control unit 53 executes control to display a file of a separate category. A specific example of displaying a file of a separate category will be explained while referencing FIGS. 13A and 13B described later. When this processing ends, the processing advances to Step S99.

Next, a specific example of processing related to an object in accordance with an operation to the input unit 17 will be explained. In the present embodiment, an example of changing the processing related to an object depending on a difference in the distance between the finger 101 and the input unit 17, even in a case of making a flick operation, will be explained.

FIGS. 13A and 13B are views showing states in which a flick operation is made on the input unit 17 of the information processing device in FIG. 1.

As shown in FIG. 13A, a file 131-1 in which a model wearing a blouse is posing is displayed in the middle of the display unit 16. In addition, a file 131-2 in which a model wearing a long T-shirt is posing is displayed on the left of the display unit 16. Furthermore, a file 131-3 in which a model wearing a one-piece dress with a ribbon is posing is displayed on the right of the display unit 16. The file 131-1, file 131-2 and file 131-3 are organized according to separate files of separate categories that differ from each other, and each is stored in the storage unit 19.

In addition, as shown in FIG. 13B, a file 141-1 in which a model wearing a red blouse is posing is displayed in the middle of the display unit 16. Furthermore, a file 141-2 in which a model wearing a blue blouse is posing is displayed on the left of the display unit 16. Moreover, a file 141-3 in which a model wearing a yellow blouse is posing is displayed on the right of the display unit 16. The model posing in the file 141-1, the model posing in the file 141-2, and the model posing in the file 141-3 each uses the same model as each other. Therefore, the file 141-1, file 141-2 and file 141-3 are organized according to separate files of the same category (blouse) as each other, and each is stored in the storage unit 19.

As shown in FIG. 13A, in a case of the user making a flick operation with the distance between the input unit 17 and the finger 101 being 0, i.e. in a case of making a flick operation by maintaining a state contacting the finger 101 to the input unit 17, the control unit 53 determines that a touch operation has been accepted at the resistive touch panel 31b, and executes seventh processing as the processing related to the object.

In contrast, as shown in FIG. 13B, in a case of a flick operation in a state of the distance between the input unit 17 and the finger 101 being far, i.e. in a case of making a flick operation by maintaining a state in which the finger 101 is in noncontact relative to the input unit 17, the control unit 53 determines that a touch operation has been accepted at the capacitive touch panel 31a, and executes eighth processing as the processing related to the object.

Herein, the seventh processing and eighth processing may be any processing so long as being different processing from each other; however, in the present embodiment, processing to read from the storage unit 19 a separate file of a separate category from the file currently being displayed on the display unit 16, and to change a file (one type of object) being displayed on the display unit 16 to the new file thus read to be displayed in the middle of the display unit 16 is adopted as the seventh processing. In addition, processing to read from the storage unit 19 a separate file of the same category as the file currently being displayed on the display unit 16, and to change the file (another type of object) to be displayed on the display unit 16 to the new file thus read and display in the middle of the display unit 16 is adopted as the eighth processing.

More specifically, in a case of the user making a flick operation to the right side with the distance between the input unit 17 and the finger 101 being 0 (case of FIG. 13A), the control unit 53 changes the file 131-1 being displayed in the middle of the display unit 16 to the separate file 131-2 of a separate category to be displayed in the middle of the display unit 16. Similarly, in a case of the user making a flick operation to the left side with the distance between the input unit 17 and the finger 101 being 0 (case of FIG. 13A), the control unit 53 changes the file 131-1 being displayed in the middle of the display unit 16 to the separate file 131-3 of a separate category to be displayed in the middle of the display unit 16.

In contrast, in a case of the user making a flick operation to the right side in a state in which the distance between the input unit 17 and the finger 101 is far (case of FIG. 13B), the control unit 53 changes the file 141-1 being displayed in the middle of the display unit 16 to the separate file 141-2 of the same category to be displayed in the middle of the display unit 16. Similarly, in a case of the user making a flick operation on the left side in a state in which the distance between the input unit 17 and the finger 101 is separated (case of FIG. 13B), the control unit 53 changes the file 141-1 being displayed in the middle of the display unit 16 to the separate file 141-3 of the same category to be displayed in the middle of the display unit 16.

The information processing device 1 according to the fifth embodiment of the present invention has been explained in the foregoing.

Next, an information processing device 1 according to a sixth embodiment of the present invention will be explained.

### Sixth Embodiment

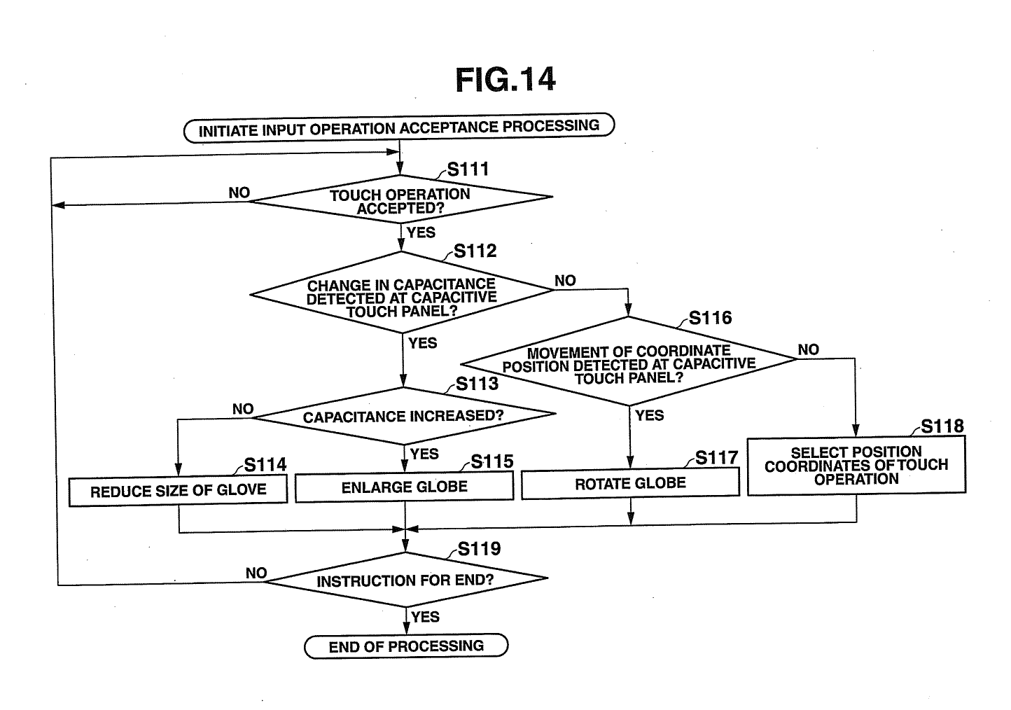

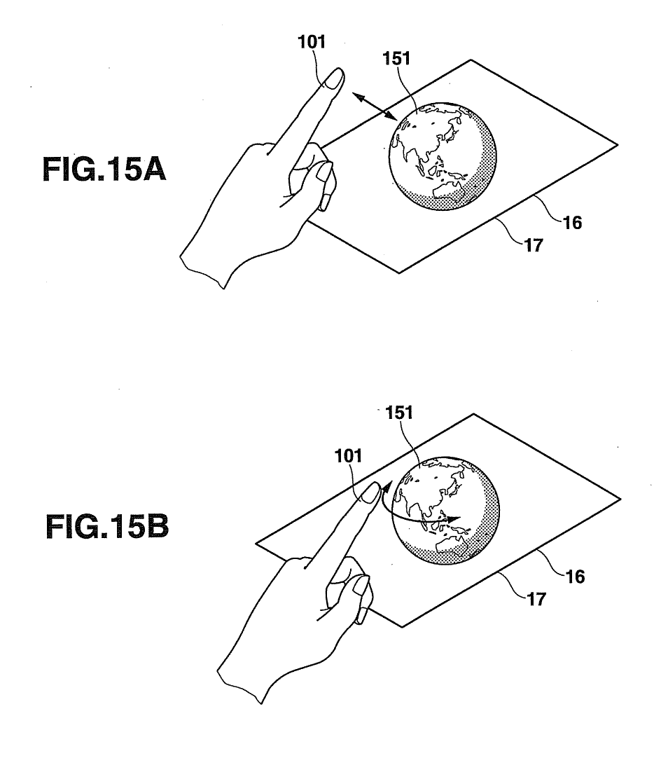

Next, input operation acceptance processing of the sixth embodiment executed by such an information processing device 1 of the functional configuration of FIG. 2 will be explained while referencing FIGS. 14, 15A and 15B. In the sixth embodiment, depending on whether or not the user has made a touch operation to the capacitive touch panel 31a, processing is performed such as to reduce in size or enlarge the image of a globe (one type of object) being displayed on the display unit 16, as the control related to the object.

When the input operation acceptance processing of the sixth embodiment is executed by the information processing device 1, each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing of each of the following steps will be provided, with each functional block functioning in the CPU 11 as the executor.

FIG. 14 is a flowchart illustrating the flow of input operation acceptance processing of the sixth embodiment executed by the information processing device 1 of FIG. 1 having the functional configuration of FIG. 2.

The input operation acceptance processing is initiated on the condition of a power button (not illustrated) of the information processing device 1 having been depressed by the user, upon which the following such processing is repeatedly executed.

In Step S111, the input operation acceptance unit 51 determines whether or not a touch operation by the user to the touch panel 31 has been accepted. In a case of a touch operation by the user to the touch panel 31 not having been performed, it is determined as NO in Step S111, and the processing is returned back to Step S111. More specifically, in a period until a touch operation is performed, the determination processing of Step S111 is repeatedly executed, and the input operation acceptance processing enters a standby state. Subsequently, in a case of a touch operation having been performed, it is determined as YES in Step S111, and the processing advances to Step S112.

In Step S112, the distance specification unit 52 determines whether or not a change in the capacitance is detected at the capacitive touch panel 31a. More specifically, the distance specification unit 52 determines whether or not an instruction operation related to the object (globes in FIGS. 15A and 15B described later) has been accepted, by detecting the change in capacitance. In a case of a change in capacitance having been detected at the capacitive touch panel 31a, it is determined as YES in Step S112, and the processing advances to Step S113.

In Step S113, the control unit 53 determines whether or not the capacitance detected in Step S112 is increasing. In a case of the capacitance decreasing, it is determined as NO in Step S113, and the processing advances to Step S114.

In Step S114, the control unit 53 determines that a finger or the like is moving away from the capacitive touch panel 31a, and displays the globe (one type of object) being displayed on the display unit 16 to be reduced in size. A specific example of displaying the globe on the display unit 16 to be reduced in size will be explained while referencing FIGS. 15A and 15B described later. When this processing ends, the processing advances to Step S119. The processing from Step S119 and after will be described later.

In a case of the capacitance detected in Step S112 increasing, it is determined as YES in Step S113, and the processing advances to Step S115.

In Step S115, the control unit 53 determines that the finger or the like is approaching the capacitive touch panel 31a, and displays the globe (one type of object) being displayed on the display unit 16 to be enlarged. A specific example of displaying the globe on the display unit 16 to be enlarged will be explained while referencing FIGS. 15A and 15B described later. When this processing ends, the processing advances to Step S119. The processing from Step S119 and after will be described later.

In a case of a change in the capacitance not having been able to be detected at the capacitive touch panel 31a, it is determined as NO in Step S112, and the processing advances to Step S116.

In Step S116, the control unit 53 determines whether or not movement of the coordinate position has been detected at the capacitive touch panel 31a. In a case of having detected movement of the coordinate position, it is determined as YES in Step S116, and the processing advances to Step S117.

In Step S117, the control unit 53 determines that a flick operation has been performed on the capacitive touch panel 31a in a state in which the distance between a finger or the like and the capacitive touch panel 31a is constant, and displays the globe (one type of object) being displayed on the display unit 16 to be rotated. A specific example of displaying the globe on the display unit 16 to be rotated will be explained while referencing FIGS. 15A and 15B described later. When this processing ends, the processing advances to Step S119. The processing from Step S119 and after will be described later.

In a case of not having been able to detect movement of the coordinate position at the capacitive touch panel 31a, it is determined as NO in Step S116, and the processing advances to Step S118.

In Step S118, the control unit 53 determines that a touch operation has been performed on the resistive touch panel 31b, and selects the position coordinates at which the touch operation was made on the globe (one type of object) being displayed on the display unit 16. A specific example of selecting the position coordinates at which the touch operation was made will be explained while referencing FIGS. 15A and 15B described later. When this processing ends, the processing advances to Step S119.

In Step S119, the control unit 53 determines whether or not there is an instruction of input operation acceptance end. In a case of there not being an instruction of input operation acceptance end, it is determined as NO in Step S119, and the processing is returned to Step S111. More specifically, in a period until there is an instruction of input operation acceptance end, the processing of Steps S111 to S119 is repeatedly performed.

By configuring in this way, it is possible to control to display an image (object) being displayed on the display unit 16 to be reduced in size or enlarged, by repeating a touch operation on the touch panel 31, in a period until the user performs an instruction of input operation acceptance end. In addition, control can be performed to rotate an image (object) being displayed on the display unit 16, and select a position coordinate at which a touch operation is made. Subsequently, in a case of an instruction of input operation acceptance end being made by the user performing a predetermined operation to the information processing device 1, for example, it is determined as YES in Step S119, and the input operation acceptance processing comes to an end.

Next, a specific example of processing related to an object in accordance with an operation to the input unit 17 will be explained.

An example of changing the processing on the globe (one type of object) displayed on the display screen (two-dimensional plane) of the display unit 16 depending on a difference in the distance between the finger 101 and the input unit 17 will be explained.

FIGS. 15a and 15B are views showing states in which a flick operation is made on the input unit 17 of the information processing device in FIG. 1, while bringing a finger close thereto or keeping away therefrom.

As shown in FIG. 15A, in a case of the user moving the finger 101 in a direction distancing from the input unit 17, the control unit 53 executes ninth processing as the processing related to the object.

In contrast, as shown in FIG. 15A, in a case of the user moving the finger 101 in a direct approaching the input unit 17, the control unit 53 executes tenth processing as the processing related to the object.

In addition, as shown in FIG. 15B, in a case of the user making a flick operation in a state keeping the distance between the input unit 17 and the finger 101 constant, the control unit 53 executes eleventh processing as the processing related to the object.

In contrast, as shown in FIG. 15B, in a case of the user making a touch operation by causing the finger 101 to contact the resistive touch panel 31b, the control unit 53 executes twelfth processing as the processing related to the object.

In other words, in the case of the user moving the finger 101 so that the distance between the input unit 17 and the finger 101 increases (case of FIG. 15A), the control unit 53 performs control to cause the globe 151 being displayed on the display unit 16 to be reduced in size. In contrast, in the case of the user moving the finger 101 so that the distance between the input 17 and the finger 101 decreases (case of FIG. 15A), the control unit 53 performs control to cause the globe 151 being displayed on the display unit 16 to be enlarged.

In addition, in the case of the user making a flick operation in a state keeping the distance between the input unit 17 and the finger 101 constant (case of FIG. 15B), the control unit 53 performs control to cause the globe 151 being displayed on the display unit 16 to be rotated. In contrast, in the case of the user making a touch operation by causing the finger 101 to contact the resistive touch panel 31b (case of FIG. 15B), the control unit 53 performs control to select a position coordinate at which the touch operation was made on the globe 151 being displayed on the display unit 16.

It should be noted that, although control is performed to display the globe 151 being displayed on the display unit 16 to be reduced in size or enlarged based on whether or not the capacitance of the capacitive touch panel 31a fluctuates in the present embodiment, it is not limited thereto. For example, control can be performed to display the globe 151 changing the rotation speed thereof based on the fluctuation in capacitance of the capacitive touch panel 31a. More specifically, in a case of the amount of change in the capacitance of the capacitive touch panel 31a decreasing, i.e. in a case of the user performing a flick operation in a state distancing the finger 101 from the capacitive touch panel 31a, the control unit 53 performs control to display the globe 151 being displayed on the display unit 16 to be rotated at high speed. In contrast, in a case of the amount of change in the capacitance of the capacitive touch panel 31a increasing, i.e. in a case of the user performing a flick operation in a state bringing the finger 101 towards the capacitive touch panel 31a, the control unit 53 performs control to display the globe 151 being displayed on the display unit 16 to be rotated at low speed.

The information processing device 1 according to the sixth embodiment of the present invention has been explained in the foregoing.

Next, an information processing device 1 according to a seventh embodiment of the present invention will be explained.

### Seventh Embodiment

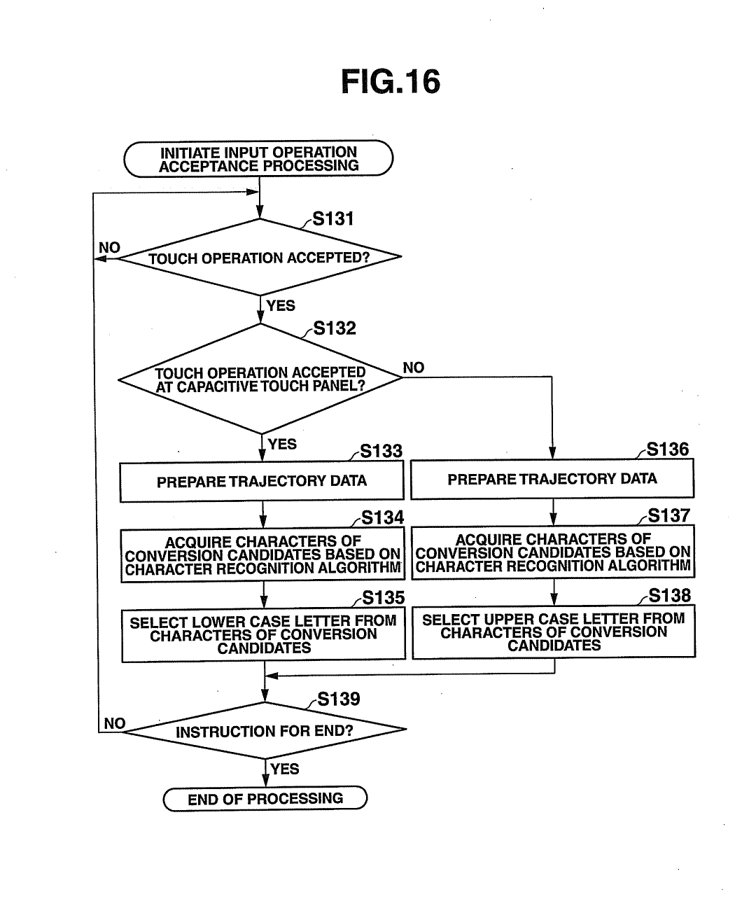

Next, input operation acceptance processing of the seventh embodiment executed by such an information processing device 1 of the functional configuration of FIG. 2 will be explained while referencing FIG. 16. In the seventh embodiment, depending on whether or not the user has made a touch operation to the capacitive touch panel 31a, processing is performed to select different character types such as to select a lower case letter or to select an upper case letter as the character of conversion candidates acquired by way of a character recognition algorithm, as control related to the object.

FIG. 16 is a flowchart illustrating the flow of input operation acceptance processing of the seventh embodiment executed by the information processing device 1 of FIG. 1 having the functional configuration of FIG. 2.

The input operation acceptance processing is initiated on the condition of a power button (not illustrated) of the information processing device 1 having been depressed by the user, upon which the following such processing is repeatedly executed.

In Step S131, the input operation acceptance unit 51 determines whether or not a touch operation by the user to the touch panel 31 has been accepted. In a case of a touch operation by the user to the touch panel 31 not having been performed, it is determined as NO in Step S131, and the processing is returned back to Step S131. More specifically, in a period until a touch operation is performed, the determination processing of Step S131 is repeatedly executed, and the input operation acceptance processing enters a standby state. Subsequently, in a case of a touch operation having been performed, it is determined as YES in Step S131, and the processing advances to Step S132.

In Step S132, the distance specification unit 52 determines whether or not a touch operation has been accepted at the capacitive touch panel 31a. More specifically, the distance specification unit 52 determines whether or not an instruction operation related to an object has been accepted at the capacitive touch panel 31a, by specifying the distance (i.e. coordinate of position in height direction) between the touch panel 31 of the input unit 17 and a body such as a hand, finger, etc. opposing this touch panel 31. In a case of a touch operation having been accepted at the capacitive touch panel 31a, it is determined as YES in Step S132, and the processing advances to Step S133.

In Step S133, the input operation acceptance unit 51 acquires the coordinates of each position of the finger moved from touch-down to touch-up. Then, the control unit 53 prepares trajectory data based on the trajectory of the coordinates of each position acquired by the input operation acceptance unit 51. It should be noted that the control unit 53 performs control to display a character stroke corresponding to the prepared trajectory data on the display unit 16.

In Step S134, the control unit 53 acquires characters of a plurality of conversion candidates based on a known character recognition algorithm, according to pattern matching or the like, based on the trajectory data prepared in Step S133.

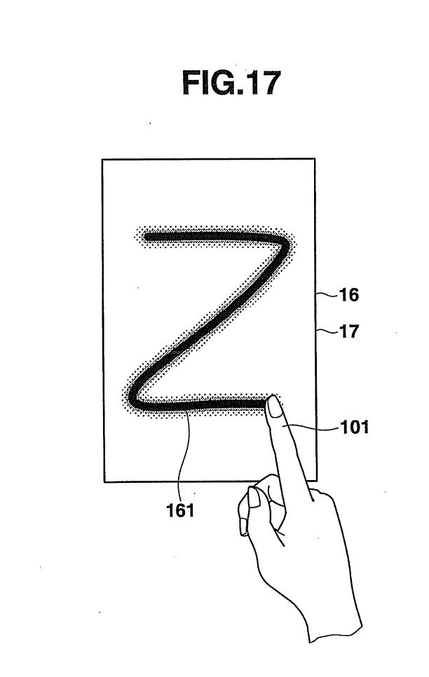

In Step S135, the control unit 53 selects a lower case letter from the characters of the plurality of conversion candidates acquired in Step S134. Then, the control unit 53 performs control to display the selected lower case letter on the display unit 16. A specific example of selecting s lower case letter from the characters of conversion candidates will be explained while referencing FIG. 17 described later. When this processing ends, the processing advances to Step S139. The processing from Step S139 and after will be described later.

In a case of a touch operation not having been accepted at the capacitive touch panel 31a, it is determined as NO in Step S132, and the processing advances to Step S136.

In Step S136, the input operation acceptance unit 51 acquires the coordinates of each position of the finger moved from touch-down to touch-up. Then, the control unit 53 prepares trajectory data based on the trajectory of the coordinates at each position acquired by the input operation acceptance unit 51. It should be noted that the control unit 53 performs control to display character strokes corresponding to the prepared trajectory data on the display unit 16.

In Step S137, the control unit acquires the characters of a plurality of conversion candidates based on a known character recognition algorithm, by way of pattern matching or the like, based on the trajectory data prepared in Step S136.

In Step S138, the control unit 53 selects an upper case letter from the characters of the plurality of conversion candidates acquired in Step S137. Then, the control unit 53 performs control to display the selected upper case letter on the display unit 16. A specific example of selecting an upper case letter from the characters of the conversion candidates will be explained while referencing FIG. 17 described later. When this processing ends, the processing advances to Step S139.

In Step S139, the control unit 53 determines whether or not there is an instruction of input operation acceptance end. In a case of there not being an instruction of input operation acceptance end, it is determined as NO in Step S139, and the processing is returned to Step S131. More specifically, in a period until there is an instruction of input operation acceptance end, the processing of Steps S131 to S139 is repeatedly performed.

By configuring in this way, it is possible to perform control to select and display a lower case letter or an upper case letter as the character of the conversion candidates acquired by way of a character recognition algorithm, by repeating a touch operation on the touch panel 31, in a period until the user performs an instruction of input operation acceptance end. Subsequently, in a case of an instruction of input operation acceptance end being made by the user performing a predetermined operation to the information processing device 1, for example, it is determined as YES in Step S139, and the input operation acceptance processing comes to an end.

Next, a specific example of processing related to an object in accordance with an operation to the input unit 17 will be explained.

An example of selecting either character (one type of object) among a lower case letter and an upper case letter from the characters of the conversion candidates depending on a difference in the distance between the finger 101 and the input unit 17 will be explained while referencing FIG. 17.

FIG. 17 is a view showing a display example of a character stroke 161 corresponding to trajectory data prepared based on the coordinates at each position of the finger moved from touch-down to touch-up.

The control unit 53 prepares trajectory data based on the trajectory of the coordinates of each position acquired by the input operation acceptance unit 51, performs pattern matching or the like on the prepared trajectory data based on a known character recognition algorithm, and acquires the characters of a plurality of conversion candidates.

In a case of the user moving a finger from touch-up to touch-down in a state of the distance between the input unit 17 and the finger 101 being far, i.e. in a case of making a touch operation to the capacitive touch panel 31a, the control unit 53 executes thirteenth processing as the processing related to the object. In contrast, in a case of the user moving the finger from touch-up to touch-down in a state making the distance between the input unit 17 and the finger 101 substantially 0 (contacting), i.e. in a case of making a touch operation to the resistive touch panel 31b, the control unit 53 executes fourteenth processing as the processing related to the object.

In other words, in a case of the user making a touch operation in a state in which the distance between the input unit 17 and the finger 101 is far, the control unit 53 selects the lower case letter as the character selected based on the character recognition algorithm. In contrast, in a case of the user making a touch operation in a state making the distance between the input unit 17 and the finger 101 substantially 0, the control unit 53 selects the upper case letter as the character selected based on the character recognition algorithm.

It should be noted that, although the lower case letter is selected or the upper case letter is selected from the characters of the conversion candidates based on whether or not a touch operation has been accepted at the capacitive touch panel 31a in the present embodiment, it is not limited thereto. For example, it is possible to select either a character with an accent mark or a normal character without an accent mark, and select any character among a normal character and a subscript character, based on whether or not a touch operation has been accepted at the capacitive touch panel 31a. More specifically, in a case of accepting a touch operation at the capacitive touch panel 31a, i.e. in a case of the user making a touch operation in a state distancing the finger 101 from the touch panel 31, the control unit 53 selects the character with an accent mark or the subscript character from the conversion candidates. In contrast, in a case of not having accepted a touch operation at the capacitive touch panel 31a, i.e. in a case of the user making a touch operation in a state contacting the finger 101 to the resistive touch panel 31b, the control unit 53 selects the normal character without an accent or subscript.

The information processing device 1 according to the seventh embodiment of the present invention has been explained in the foregoing.

Next, an information processing device 1 according to an eighth embodiment of the present invention will be explained.

### Eighth Embodiment

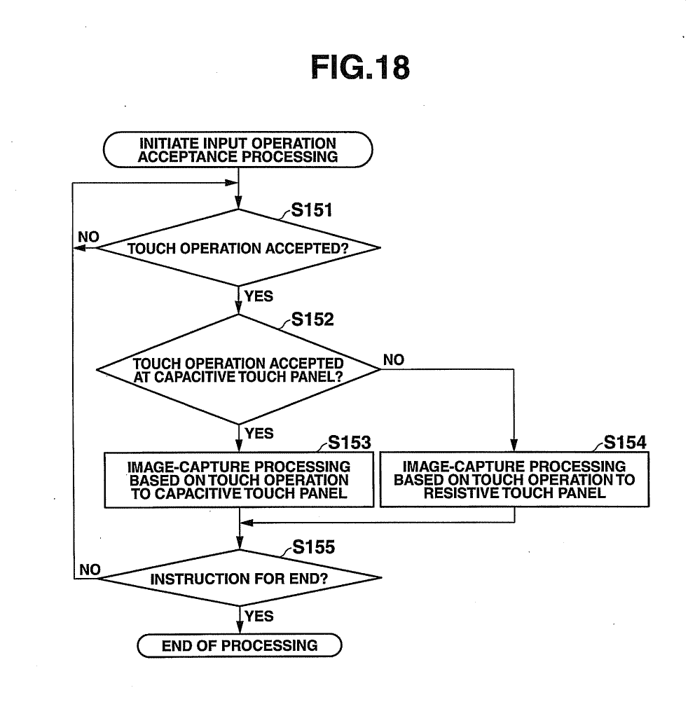

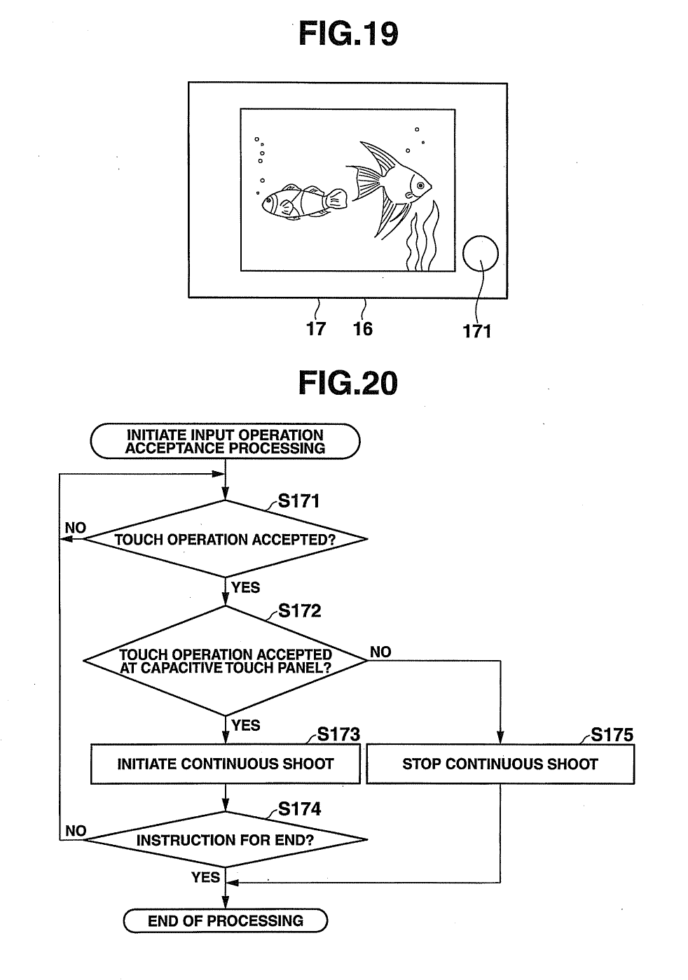

Next, input operation acceptance processing of the eighth embodiment executed by such an information processing device 1 of the functional configuration of FIG. 2 will be explained while referencing FIGS. 18 and 19. In the eighth embodiment, depending on whether or not the user has made a touch operation to the capacitive touch panel 31a, processing is performed such as to perform image capturing based on a touch operation to the capacitive touch panel 31a, or to perform image capturing based on a touch operation to the resistive touch panel 31b, as the control related to an object.

When input operation acceptance processing of the eighth embodiment is executed by the information processing device 1, each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing in each of the following steps will be provided with each functional block functioning in the CPU 11 as the executor.

FIG. 18 is a flowchart illustrating the flow of input operation acceptance processing of the eighth embodiment executed by the information processing device 1 of FIG. 1 having the functional configuration of FIG. 2.

The input operation acceptance processing is initiated on the condition of a power button (not illustrated) of the information processing device 1 having been depressed by the user, upon which the following such processing is repeatedly executed.

In Step S151, the input operation acceptance unit 51 determines whether or not a touch operation by the user to the touch panel 31 has been accepted. In a case of a touch operation by the user to the touch panel 31 not having been performed, it is determined as NO in Step S151, and the processing is returned back to Step S151. More specifically, in a period until a touch operation is performed, the determination processing of Step S151 is repeatedly executed, and the input operation acceptance processing enters a standby state. Subsequently, in a case of a touch operation having been performed, it is determined as YES in Step S151, and the processing advances to Step S152.

In Step S152, the distance specification unit 52 determines whether or not a touch operation has been accepted at the capacitive touch panel 31a. More specifically, the distance specification unit 52 determines whether or not an instruction operation related to an object has been accepted at the capacitive touch panel 31a, by specifying the distance (coordinate of the position in the height direction) between the touch panel 31 of the input unit 17 and a body such as a hand, finger, etc. opposing this touch panel 31. In a case of a touch operation having been accepted at the capacitive touch panel 31a, it is determined as YES in Step S152, and the processing advances to Step S153.

In Step S153, the control unit 53 performs control to perform image-capture processing based on a touch operation to the capacitive touch panel 31a. A specific example of performing image-capture processing based on a touch operation to the capacitive touch panel 31a will be explained while referencing FIG. 19 described later. When this processing ends, the processing advances to Step S155. The processing from Step S155 and after will be described later.

In a case of a touch operation not having been accepted at the capacitive touch panel 31a, it is determined as NO in Step S152, and the processing advances to Step S154.

In Step S154, the control unit 53 performs control to perform image-capture processing based on a touch operation to the resistive touch panel 31b. A specific example of performing image-capture processing based on a touch operation to the resistive touch panel 31b will be explained while referencing FIG. 19 described later. When this processing ends, the processing advances to Step S155.

In Step S155, the control unit 53 determines whether or not there is an instruction of input operation acceptance end. In a case of there not being an instruction of input operation acceptance end, it is determined as NO in Step S155, and the processing is returned to Step S151. More specifically, in a period until there is an instruction of input operation acceptance end, the processing of Steps S151 to S155 is repeatedly performed.

By configuring in this way, it is possible to perform control to initiate image-capture processing based on a touch operation to either the resistive touch panel 31b or the capacitive touch panel 31a, by repeating a touch operation to the touch panel 31 in a period until the user performs an instruction of input operation acceptance end. Subsequently, in a case of an instruction of input operation acceptance end being made by the user performing a predetermined operation to the information processing device 1, for example, it is determined as YES in Step S155, and the input operation acceptance processing comes to an end.

Next, a specific example of processing related to an object in accordance with an operation to the input unit 17 will be explained.

An example of performing control to perform image-capture processing based on the capacitive touch panel 31a (one type of object) or the resistive touch panel 31b (another type of object), depending on a difference in the distance between the finger 101 and the input unit 17, will be explained while referencing FIG. 19.

FIG. 19 is a view showing a state in which a touch operation is made on the input unit 17 of the information processing device of FIG. 1.

In the input unit 17 of the present embodiment, the capacitive touch panel 31a is arranged on substantially the entirety of the display unit 16; whereas, the resistive touch panel 31b is arranged on only a predetermined area 171 disposed on the right side of the display unit 16.

In a case of the user making a touch operation with the distance between the input unit 17 and the finger 101 being 0, i.e. in a case of making a touch operation by maintaining a state contacting the finger 101 to the input unit 17, the control unit 53 determines that a touch operation has been accepted at the resistive touch panel 31b, and executes fifteenth processing as the processing related to the object.

In contrast, in a case of the user making a touch operation in a state of the distance between the input unit 17 and the finger 101 being far, i.e. in a case of making a touch operation by maintaining a state in which the finger 101 is in noncontact relative to the input unit 17, the control unit 53 determines that a touch operation has been accepted at the capacitive touch panel 31a, and executes sixteenth processing as the processing related to the object.

Herein, the fifteenth processing and sixteenth processing may be any processing so long as being different processing from each other; however, in the present embodiment, image-capture processing to perform image capture based on a touch operation to the capacitive touch panel 31a (one type of object) is adopted as the fifteenth processing In addition, image-capture processing to perform image capture (one type of object) based on a touch operation to the resistive touch panel 31b (separate type of object) is adopted as the sixteenth processing.

In other words, in a case of the user making a touch operation with the distance between the input unit 17 and the finger 101 of 0, the control unit 53 executes control to perform image capture based on a touch operation to the resistive touch panel 31b. In contrast, in a case of the user making a touch operation in a state of the distance between the input unit 17 and the finger 101 being far, the control unit 53 executes control to perform image capture based on a touch operation to the capacitive touch panel 31a.

While the capacitive touch panel 31a can operate with a light operation sensation, the sensitivity drops in a state underwater or with water drops, and operation will no longer be possible. In the present embodiment, image capturing can be instructed with a light operation sensation by way of the capacitive touch panel 31a, and image capturing can be instructed with a positive operation sensation by way of the resistive touch panel 31b under an environment underwater or with water drops.

The information processing device 1 according to the eighth embodiment of the present invention has been explained in the foregoing.

Next, an information processing device 1 according to a ninth embodiment of the present invention will be explained.

### Ninth Embodiment

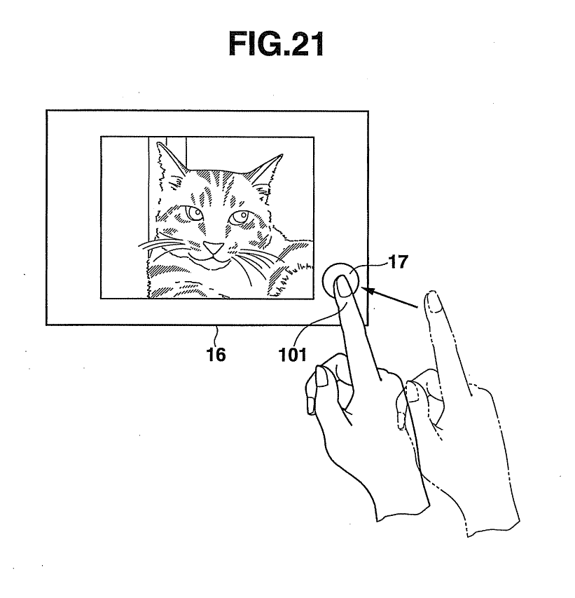

Next, input operation acceptance processing of the ninth embodiment executed by such an information processing device 1 of the functional configuration of FIG. 2 will be explained while referencing FIGS. 20 and 21. In the ninth embodiment, depending on whether or not the user has made a touch operation to the capacitive touch panel 31a, processing is performed such as to initiate continuous shoot or stop continuous shoot as the control related to the object.

Continuous shoot refers to processing to primarily store in a buffer (not illustrated) data of captured images consecutively captured by the image-capturing unit 18. In addition, stopping continuous shoot refers to processing to record data of captured images primarily stored in the buffer by way of continuous shoot into the storage unit 19 or removable media 41, and to stop consecutive image capturing.

When input operation acceptance processing of the ninth embodiment is executed by the information processing device 1, each functional block of the CPU 11 in FIG. 2 functions, and the following such processing is performed. In other words, in terms of hardware, the executor for the processing of each of the following steps is the CPU 11. However, in order to facilitate understanding of the present invention, an explanation of the processing in each of the following steps will be provided with each functional block functioning in the CPU 11 as the executor.

FIG. 20 is a flowchart illustrating the flow of input operation acceptance processing of the ninth embodiment executed by the information processing device 1 of FIG. 1 having the functional configuration of FIG. 2.

The input operation acceptance processing is initiated on the condition of a power button (not illustrated) of the information processing device 1 having been depressed by the user, upon which the following such processing is repeatedly executed.

In Step S171, the input operation acceptance unit 51 determines whether or not a touch operation by the user to the touch panel 31 has been accepted. In a case of a touch operation by the user to the touch panel 31 not having been performed, it is determined as NO in Step S171, and the processing is returned back to Step S171. More specifically, in a period until a touch operation is performed, the determination processing of Step S171 is repeatedly executed, and the input operation acceptance processing enters a standby state. Subsequently, in a case of a touch operation having been performed, it is determined as YES in Step S171, and the processing advances to Step S172.

In Step S172, the distance specification unit 52 determines whether or not a touch operation has been accepted at the capacitive touch panel 31a. More specifically, the distance specification unit 52 determines whether or not an instruction operation related to an object has been accepted at the capacitive touch panel 31a, by specifying the distance (coordinate of the position in the height direction) between the touch panel 31 of the input unit 17 and a body such as a hand, finger, etc. opposing this touch panel 31. In a case of a touch operation having been accepted at the capacitive touch panel 31a, it is determined as YES in Step S172, and the processing advances to Step S173.

In Step S173, the control unit 53 determines that a touch operation has been made to the capacitive touch panel 31a, and performs control to initiate continuous shoot. A specific example of initiating continuous shoot will be explained while referencing FIG. 21 described later. When this processing ends, the processing advances to Step S174.

In Step S174, the control unit 53 determines whether or not there is an instruction of input operation acceptance end. In a case of there not being an instruction of input operation acceptance end, it is determined as NO in Step S174, and the processing is returned to Step S171. More specifically, in a period until there is an instruction of input operation acceptance end, the processing of Steps S171 to S174 is repeatedly performed.

By configuring in this way, it is possible to continually perform continuous shoot, by continuing a touch operation on the touch panel 31a, in a period until the user performs an instruction of input operation acceptance end. Subsequently, in a case of an instruction of input operation acceptance end being made by the user performing a predetermined operation to the information processing device 1, for example, it is determined as YES in Step S174, and the input operation acceptance processing comes to an end.

In a case of a touch operation not having been accepted at the capacitive touch panel 31a, it is determined as NO in Step S172, and the processing advances to Step S175.

In Step S175, the control unit 53 determines that a touch operation has been made to the resistive touch panel 31b, and performs control to stop continuous shoot. A specific example of stopping continuous shoot will be explained while referencing FIG. 21 described later. When this processing ends, the input operation acceptance processing comes to an end.

Next, a specific example of processing related to an object in accordance with an operation to the input unit 17 will be explained.

FIG. 21 is a view showing a state in which a touch operation is made on the input unit of the information processing device of FIG. 1. In the present embodiment, the input unit 17 is arranged in the vicinity of the right-side edge of the display unit 16.

In a case of the user making a touch operation in a state of the distance between the input unit 17 and the finger 101 being far, i.e. in a case of making a touch operation by maintaining a state in which the finger 101 is in noncontact relative to the input unit 17, the control unit 53 determines that a touch operation has been accepted at the capacitive touch panel 31a (one type of object), and executes seventeenth processing as the processing related to the object.

In contrast, in a case of the user making a touch operation with the distance between the input unit 17 and the finger 101 being 0, i.e. in a case of making a touch operation by maintaining a state contacting the finger 101 to the input unit 17, the control unit 53 determines that a touch operation has been accepted at the resistive touch panel 31b (another type of object), and executes eighteenth processing as the processing related to the object.

Herein, the seventeenth processing and eighteenth processing may be any processing so long as being different processing from each other; however, in the present embodiment, processing to initiate continuous shoot based on a touch operation to the capacitive touch panel 31a is adopted as the seventeenth processing

In addition, processing to stop continuous shoot based on a touch operation to the resistive touch panel 31b is adopted as the eighteenth processing.

In other words, in a case of the user making a touch operation in a state in which the distance between the input unit 17 and the finger 101 is far, the control unit 53 initiates continuous shoot and continuously stores data of captured images in a buffer (not illustrated) temporarily based on a touch operation to the capacitive touch panel 31a. Then, in a case of the user making a touch operation with the distance between the input unit 17 and the finger 101 being 0, the control unit 53 stores in the removable media 41 the data of captured images stored in the buffer based on a touch operation to the resistive touch panel 31b. The control unit 53 stops continuous shoot by storing the data of captured images in the removable media 41. It is thereby possible to capture images at a desired image-capturing timing without missing a photo opportunity, by performing continuous shoot from a moment when a user feels like image capturing until image capturing, and eliminating the lag between the timing at which a user performs an image capture action and the timing at which an image is actually captured.

As explained in the foregoing, the information processing device 1 of the present embodiment includes the input operation acceptance unit 51, distance specification unit 52, and control unit 53.

The input operation acceptance unit 51 accepts movement of a body that is substantially parallel to the display surface (two-dimensional plane) of the display unit 16 on which the touch panel 31 is laminated, as a touch operation to the touch panel 31.

In a case of a touch operation having been made, the distance specification unit 52 detects a distance of the body from the display surface (two-dimensional plane) of the display unit 16.

The control unit 53 variably controls the execution of processing related to an object displayed, based on the type of touch operation accepted by the input operation acceptance unit 51 (types differ depending on the trajectory of movement of the body), and the distance of the body detected by the distance specification unit 52 in a normal vector direction from the display surface of the display unit 16.

It is thereby possible to perform various instructions for processing related to an object, by simply intuitively performing a gesture operation (intuitive touch operation of making a body such as a finger or hand move), even for a user inexperienced in operations on the touch panel 31. It is thereby possible to easily instruct processing of an object, even for a user inexperienced in the touch panel 31.

Furthermore, the control unit 53 of the information processing device 1 of the present embodiment is configured so as to recognize an executed touch operation among the several types of touch operations, based on the type of touch operation (movement operation) accepted by the input operation acceptance unit 51 and the distance specified by the distance specification unit 52, and to control processing related to the object and associated with this touch operation. It is thereby possible to perform various instructions for processing related to an object, by simply changing the distance when intuitively performing a gesture operation, even for a user inexperienced in operations on the touch panel 31. It is thereby possible to easily instruct processing of an object, even for a user inexperienced in the touch panel 31.

Furthermore, the control unit 53 of the information processing device 1 of the present embodiment is configured so as to execute control to either skip a page of the object displayed on the display surface of the display unit 16 or read a separate object, depending on the distance specified by the distance specification unit 52. It is thereby possible to skip a page of the contents of a comic strip being displayed on the display unit 16, or change to contents of a following volume in place of the contents of the comic strip currently being displayed, by simply changing the distance when intuitively performing a gesture operation, even for a user inexperienced in operations on the touch panel 31. It is thereby possible to easily instruct to change the control of the contents being displayed on the display unit 16, even for a user inexperienced in the touch panel 31.

Furthermore, the control unit 53 of the information processing device 1 of the present embodiment is configured so as to execute control of an object displayed on the display surface of the display unit 16 to either rotate to any angle or rotate to a prescribed angle, depending on the distance specified by the distance specification unit 52. It is thereby possible to smoothly rotate the angle of a picture being displayed on the display unit 16 to either an arbitrary angle, or to broadly rotate to a prescribed angle set in advance, by simply changing the distance when intuitively performing a gesture operation, even for a user inexperienced in operations on the touch panel 31. It is thereby possible to easily instruct the rotation angle of an object being displayed on the display unit 16, even for a user inexperienced in the touch panel 31.

Furthermore, the control unit 53 of the information processing device 1 of the present embodiment is configured so as to execute control of depress processing on a button arranged on any layer among the buttons arranged on the plurality of layers for displaying a 3D scene, depending on the distance specified by the distance specification unit 52. It is thereby possible to either conduct depress processing on a button arranged on a highest layer for displaying 3D contents or conduct depress processing on a button arranged on a lowest layer, by simply changing the distance when intuitively performing a gesture operation, even for a user inexperienced in operations on the touch panel 31. It is thereby possible to easily instruct depress processing on buttons arranged on a plurality of layers being displayed on the display unit 16, even for a user inexperienced in the touch panel 31.

Furthermore, the control unit 53 of the information processing device 1 of the present embodiment is configured so as to execute control to either select a plurality of files displayed on the display surface of the display unit 16, or select only a part of the files, depending on the distance specified by the distance specification unit 52. It is thereby possible to select a plurality of files that are within a specified range being displayed on the display unit 16 by file management software or the like, or to select only a part of the files, by simply changing the distance when intuitively performing a gesture operation, even for a user inexperienced in operations on the touch panel 31. It is thereby possible to easily instruct a change in the control of a page or files displayed on the display unit 16, even for a user inexperienced in the touch panel 31.

Furthermore, the control unit 53 of the information processing device 1 of the present embodiment is configured so as to execute control to either set the file to be displayed on the display surface of the display unit 16 to a separate file of the same category, or to set to a separate file of a separate category, depending on the distance specified by the distance specification unit 52. It is thereby possible to either display merchandise of the same category being displayed on the display unit 16 in an electronic catalog by changing to a file of the merchandise in a different color, or display by changing to a file of different merchandise, by simply changing the distance when intuitively performing a gesture operation, even for a user inexperienced in operations on the touch panel 31. It is thereby possible to easily instruct control to change and display objects such as merchandise, even for a user inexperienced in the touch panel 31.

Furthermore, the control unit 53 of the information processing device 1 of the present embodiment is configured so as to execute control to display an object displayed on the display surface of the display unit 16 to either be enlarged or reduced in size, depending on the distance specified by the distance specification unit 52. It is thereby possible to either display 3D contents (e.g., a globe) displayed on the display unit 16 to be enlarged or display to be reduced in size freely, by simply changing the distance when intuitively performing a gesture operation, even for a user inexperienced in operations on the touch panel 31. It is thereby possible to easily instruct control to display by changing the size of contents being displayed on the display unit 16, even for a user inexperienced in the touch panel 31.

Furthermore, the control unit 53 of the information processing device 1 of the present embodiment is configured so as to execute control to either rotate or to select an object, depending on movement in three-dimensional directions. It is thereby possible to either display rotatable 3D contents (e.g., a globe) displayed on the display unit 16 to be freely rotated or display to be selected, by simply changing the distance when intuitively performing a gesture operation, even for a user inexperienced in operations on the touch panel 31. It is thereby possible to easily instruct a change in control of 3D contents or the like being displayed on the display unit 16, even for a user inexperienced in the touch panel 31.

Furthermore, the control unit 53 of the information processing device 1 of the present embodiment is configured so as to execute control to select different character types as the characters of conversion candidates acquired based on the results of character recognition, depending on the distance specified by the distance specification unit 52. It is thereby possible to either select the character type of an upper case letter or select the character type of a lower case letter as the conversion candidate acquired based on the results of character recognition, even in a case of characters having substantially the same handwriting as an upper case letter and a lower case letter (e.g., “C” and “c”, “O” and “o”, etc.), by simply changing the distance when intuitively performing a gesture operation, even for a user inexperienced in operations on the touch panel 31. It is thereby possible to easily designate a character type of the conversion candidates, even for a user inexperienced in the touch panel 31.

Furthermore, the information processing device 1 of the present embodiment includes the image-capturing unit 18 that captures an image of a subject. Then, the control unit 53 is configured so as to capture an image by controlling the image-capturing unit 18 according to an instruction based on any touch panel 31 among the plurality of panels constituting the laminated touch panel 31, depending on the distance specified by the distance specification unit 52. It is thereby possible to capture an image by selecting a touch panel according to the characteristics of the touch panel (e.g., waterproof touch panel, touch panel excelling in sensitivity, etc.), by simply changing the distance when intuitively performing a gesture operation, even for a user inexperienced in operations on the touch panel 31. It is thereby possible to easily give an instruction of image capturing by selecting the most appropriate touch panel, even for a user inexperienced in the touch panel 31.

Furthermore, the control unit 53 of the information processing device 1 of the present embodiment is configured so as to execute any control among initiating continuous shoot by way of the image-capturing unit 18 or stopping this continuous shoot, depending on the distance specified by the distance specification unit 52. It is thereby possible to either initiate continuous shoot in order to seek a photo opportunity, or stop continuous shoot in order to perform image capturing of a photo opportunity of a moment during continuous shoot, by simply changing the distance when intuitively performing a gesture operation, even for a user inexperienced in operations on the touch panel 31. It is thereby possible to easily instruct image capturing at the most appropriate shutter timing, even for a user inexperienced in the touch panel 31.

Furthermore, the touch panel 31 of the information processing device 1 of the present embodiment is configured from the capacitive touch panel 31a and the resistive touch panel 31b.

In this case, it is possible to protect the resistive touch panel 31b by the surface of the capacitive touch panel 31a. Furthermore, it is possible to detect the coordinates of a position at which a touch operation is made in a noncontact state and the distance between the finger 101 and the capacitive touch panel 31a by way of the capacitive touch panel 31a, as well as being able to detect in more detail the coordinates of a position at which a touch operation is made by way of the resistive touch panel 31b, in a case of contact.

It should be noted that the present invention is not to be limited to the aforementioned embodiments, and that modification, improvements, etc. within a scope that can achieve the object of the present invention are included in the present invention.

Although the capacitive touch panel 31a and the resistive touch panel 31b are laminated in this sequence over the entirety of the display screen of the display of the display unit 16 in the aforementioned embodiments, it is not limited thereto. For example, the resistive touch panel 31b and the capacitive touch panel 31a may be laminated in this sequence over the entirety of the display screen of the display of the display unit 16.

In addition, although the distance specification unit 52 multiply specifies distances between the input unit 17 and a hand, finger or the like from the change in capacitance of the capacitive touch panel 31a constituting the input unit 17 in the aforementioned embodiments, it is not limited thereto. For example, the distance specification unit 52 may specify the distance detected by an ultrasonic sensor, infrared sensor, image-capturing device, or the like not illustrated.

In other words, in the aforementioned embodiments, the input operation acceptance unit 51 accepts, as a touch operation, an operation of a movement of the position in two dimensions of a body (e.g., hand or finger) in a direction substantially parallel to the display screen (two-dimensional plane) of the display unit 16. In addition, the distance specification unit 52 detects the distance of the body from the display screen, i.e. position of the body in a direction substantially parallel to a normal vector of the display screen.

In view of this, the aforementioned embodiments are equivalent to the matter of the input operation acceptance unit 51 and the distance specification unit 52 accepting an operation of movement of a body in three-dimensional directions relative to the display screen of the display unit 16 defined as the reference plane. Therefore, the input operation acceptance unit 51 and the distance specification unit 52 are collectively referred to as a “three-dimensional operation acceptance unit” hereinafter. In this case, the reference plane is not particular required to be the display screen of the display unit 16, and may be any plane.

In this case, for the reference plane, it is not necessary to use a plane that can be seen by the user with the naked eye, and a plane within any body may be used, or a virtual plane may be defined as the reference plane.

In addition, a three-dimensional position detection unit that measures a position of the body in three dimensions is configured as the capacitive touch panel 31a and the resistive touch panel 31b in the aforementioned embodiments; however, it is not limited thereto, and can be configured by combining any number of position detection units of any type. Herein, the aforementioned distance is nothing but a position of the body in a normal vector direction of the reference surface; therefore, detecting the distance is nothing but detecting a position in the normal vector direction of the reference surface.

In summary, it is sufficient if the information processing device to which the present invention is applied has the following such functions, and the embodiments thereof are not particularly limited to the aforementioned embodiments.

In other words, the information processing device to which the present invention is applied includes:

a three-dimensional position detection function of detecting a position of a body in three-dimensional directions relative to a reference plane;

a three-dimensional operation acceptance function of recognizing a movement of the body in three-dimensional directions based on each position in the three-dimensional directions of the body temporally separated and detected multiple times, and accepting the recognition result thereof as an instruction operation related to an object; and

a control function of variably controlling processing related to this object, depending on the instruction operation accepted.

In addition, although the display ratio of an icon displayed on the display of the display unit 16 is changed depending on the distance between the input unit 17 and the finger 101 in the aforementioned embodiments, it is not limited thereto. For example, it may be configured so as to be displayed by centering at a location in the vicinity of the finger 101, depending on the distance between the input unit 17 and the finger 101.

In addition, although the information processing device 1 to which the present invention is applied is explained with a smart phone as an example in the aforementioned embodiments, it is not particularly limited thereto.

For example, the present invention can be applied to general electronic devices having an image-capturing function. More specifically, for example, the present invention is applicable to notebook-type personal computers, printers, television sets, video cameras, digital cameras, portable navigation devices, portable telephones, portable videogame machines, and the like.

The aforementioned sequence of processing can be made to either be executed by hardware or executed by software.

That is, the functional configuration in FIG. 2 is merely an example and is not particularly limiting. In other words, it is sufficient that the information processing device 1 be provided with functions capable of executing the aforementioned sequence of processing as a whole, and the kinds of functional blocks used in order to realize these functions are not particularly limited to the example in FIG. 2.

In addition, the individual functional blocks may be configured by hardware units, may be configured by software units, and may be configured by combinations thereof.

If a sequence of processing is executed by software, a program constituting the software is installed to the computer or the like from a network or a recording medium.

The computer may be a computer incorporating special-purpose hardware. In addition, the computer may be a computer capable of executing various functions by installing various programs, for example, a general-purpose personal computer.

The recording medium containing such a program is configured not only by the removable media 41 in FIG. 1 that is distributed separately from the main body of the device in order to provide the program to the user, but also is configured by a recording medium provided to the user in a state incorporated in the main body of the equipment in advance, or the like. The removable media 41 is constituted by, for example, a magnetic disk (including floppy disks), an optical disk, a magneto-optical disk or the like. The optical disk is, for example, a CD-ROM (Compact Disk-Read Only Memory), DVD (Digital Versatile Disk), or the like. The magneto-optical disk is, for example, an MD (Mini-Disk), or the like. In addition, the recording medium provided to the user in a state incorporated with the main body of the equipment in advance is constituted by the ROM 12 of FIG. 1 in which a program is recorded, a hard disk included in the storage unit 19 of FIG. 1, and the like.

It should be noted that the steps describing the program recorded in the recording medium naturally include processing performed chronologically in the described order, but is not necessarily processed chronologically, and also includes processing executed in parallel or separately.

Furthermore, the terminology of system in the present specification is intended to mean the overall equipment configured by a plurality of devices, a plurality of means, etc.

Hereinafter, a tenth embodiment of the present invention will be explained using the attached drawings.

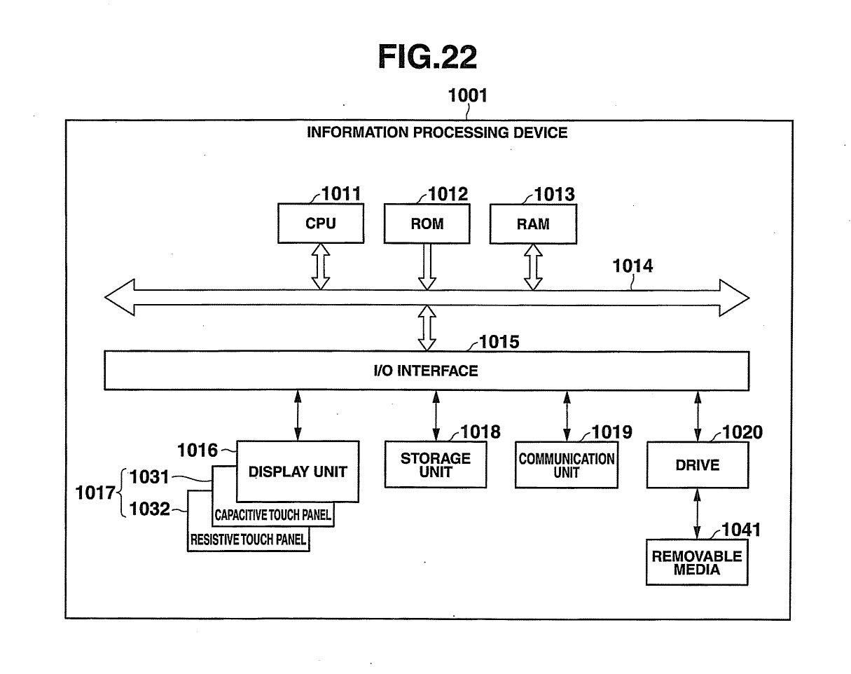

FIG. 22 is a block diagram showing a hardware configuration of an information processing device according to the tenth embodiment of the present invention. An information processing device 1001 is configured as a smart phone, for example.

The information processing device 1001 includes: a CPU (Central Processing Unit) 1011, ROM (Read Only Memory) 1012, RAM (Random Access Memory) 1013, a bus 1014, an I/O interface 1015, a display unit 1016, an input unit 1017, a storage unit 1018, a communication unit 1019, and a drive 1020.

The CPU 1011 executes a variety of processing in accordance with a program stored in the ROM 1012, or a program loaded from the storage unit 1018 into the RAM 1013.

The necessary data and the like upon the CPU 1011 executing the variety of processing are also stored in the RAM 1013 as appropriate.

The CPU 1011, ROM 1012 and RAM 1013 are connected to each other through the bus 1014. The I/O interface 1015 is also connected to this bus 1014. The display unit 1016, input unit 1017, storage unit 1018, communication unit 1019 and drive 1020 are connected to the I/O interface 1015.

The display unit 1016 is configured by a display, and displays images.

The input unit 1017 is configured by a touch panel that is laminated on the display screen of the display unit 1016, and inputs a variety of information in response to instruction operations by the user. The input unit 1017 includes a capacitive touch panel 1031 and a resistive touch panel 1032, as will be explained while referencing FIG. 24 described later.

The storage unit 1018 is configured by a hard disk, DRAM (Dynamic Random Access Memory), or the like, and stores data of various images.

The communication unit 1019 controls communication carried out with another device (not illustrated) through a network including the Internet.

Removable media 1041 constituted from magnetic disks, optical disks, magneto-optical disks, semiconductor memory, or the like are installed in the drive 1020 as appropriate. Programs read from the removable media 1041 by the drive 1020 are installed in the storage unit 1018 as necessary. Similarly to the storage unit 1018, the removable media 1041 can also store a variety of data such as data of images stored in the storage unit 1018.

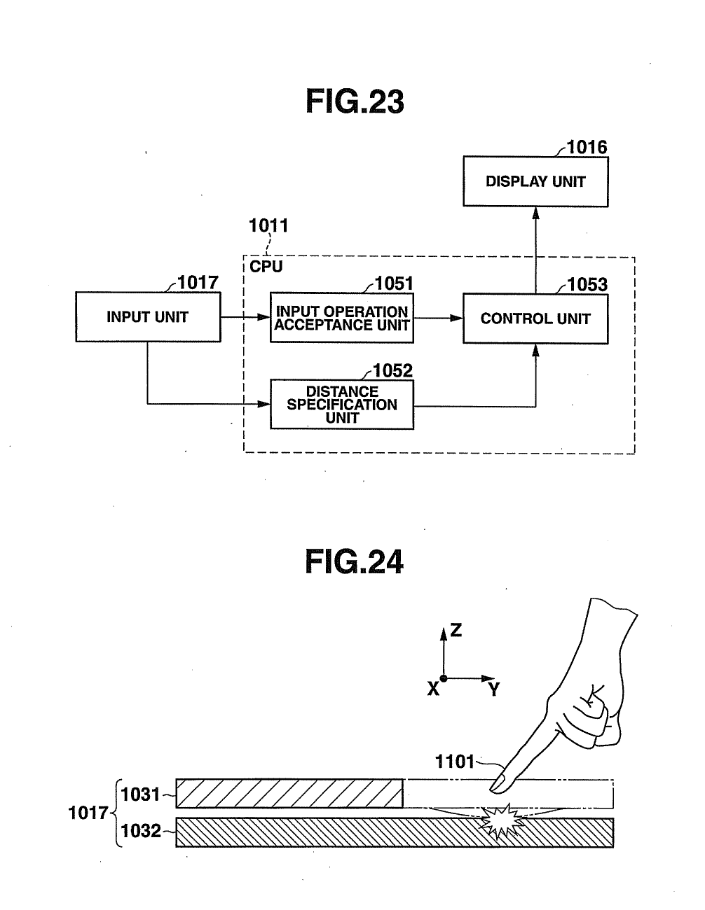

FIG. 23 is a functional block diagram showing, among the functional configurations of such an information processing device 1001, the functional configuration for executing input operation acceptance processing.

Input operation acceptance processing refers to the following such processing initiated on the condition of a power button that is not illustrated being depressed by the user. More specifically, input operation acceptance processing refers to a sequence of processing from accepting an operation on the touch panel of the input unit 17, until executing processing related to the object in response to this operation.

An input operation acceptance unit 1051, distance specifying unit 1052, and control unit 1053 in the CPU 1011 function in a case of the execution of the input operation acceptation processing being controlled.

In the present embodiment, a part of the input unit 1017 is configured as the capacitive touch panel 1031 and the resistive touch panel 1032, as shown in FIG. 24.

FIG. 24 is a cross-sectional view showing a part of the input unit 1017.

The capacitive touch panel 1031 and resistive touch panel 1032 are laminated on the entire display screen of the display of the display unit 1016 (refer to FIG. 22), and detect the coordinates at which a touch operation is made. Herein, touch operation refers to an operation of contact or near contact of a body (finger of user, touch pen, etc.) to the touch panel.

The capacitive touch panel 1031 and the resistive touch panel 1032 provide the coordinates of the detected position to the control unit 1053 via the input operation acceptance unit 1051.

The capacitive touch panel 1031 is configured by a conductive film on the display screen of the display of the display unit 1016. More specifically, since capacitive coupling occurs from only a finger tip approaching the surface of the capacitive touch panel 1031, even in a case of the finger tip not contacting the capacitive touch panel 1031, the capacitive touch panel 1031 detects the position by capturing the change in capacitance between the finger tip and the conductive film from only nearly contacting. When the user performs an operation (hereinafter referred to as “screen touch operation”) to cause a protruding object such as a finger or stylus pen to contact or nearly contact the display screen, the CPU 1011 detects the coordinates of the contact point of the finger based on such a change in capacitance between the finger tip and conductive film.

The resistive touch panel 1032 is formed by a soft surface film such as of PET (Polyethylene Terephthalate) and a liquid crystal glass film that is on an interior side being overlapped in parallel on the display screen of the display of the display unit 1016. Both films have transparent conductive films affixed thereto, respectively, and are electrically insulated from each other through a transparent spacer. The surface film and glass film each have a conductor passing therethrough, and when a user performs a screen touch operation, the surface film bends by way of the stress from the protruding object, and the surface film and glass film partially enter a conductive state. At this time, the electrical resistance value and electrical potential change in accordance with the contact position of the protruding object. The CPU 1011 detects the coordinates of the contact position of this protruding object based on the change in such an electrical resistance value and electrical potential.

Summarizing the above, the capacitive touch panel 1031 detects the position on a two-dimensional plane (on the screen) by capturing the change in capacitance between the finger tip and conductive film. Therefore, the capacitive touch panel 1031 can detect the coordinates of a position on the two-dimensional plane at which a touch operation is made, even with a finger 1101 in a noncontact state relative to the capacitive touch panel 1031, i.e. near contact state. Furthermore, in this case, it is possible to detect the distance between the finger 1101 and the capacitive touch panel 1031, in order words, the coordinates of a position of the finger 1101 in a height direction, though not at high precision.

In contrast, the resistive touch panel 1032 does not detect if a touch operation has been made with the finger 1101 in a noncontact state relative to the resistive touch panel 1032. More specifically, in a case of the finger 1101 being in a noncontact state relative to the resistive touch panel 1032, the coordinates of the position of the finger 1101 on the two-dimensional plane are not detected, and the coordinate (distance) of the position of the finger 1101 in the height direction is also not detected. However, the resistive touch panel 1032 can detect the coordinates of the position on the two-dimensional plane at which a touch operation is made with high precision and high resolution, compared to the capacitive touch panel 1031.

In the present embodiment, the capacitive touch panel 1031 and resistive touch panel 1032 are laminated in this order on the entirety of the display screen of the display of the display unit 1016; therefore, the resistive touch panel 1032 can be protected by the surface of the capacitive touch panel 1031. Furthermore, the coordinates of the position at which a touch operation is made in a noncontact state on the two-dimensional plane, and the distance between the finger 1101 and the capacitive touch panel 1031 (coordinate of the position in the height direction), i.e. coordinate of the position in three-dimensional space, can be detected by way of the capacitive touch panel 1031. On the other hand, in a case of the finger 1101 making contact, the coordinates of the position at which the touch operation is made can be detected with high precision and high resolution by way of the resistive touch panel 1032.

Referring back to FIG. 23, the input operation acceptance unit 1051 accepts a touch operation to the touch panel (capacitive touch panel 1031 and resistive touch panel 1032) of the input unit 1017 as one of the input operations to the input unit 1017, and notifies the control unit 1053 of the coordinates of the position in two-dimensions thus accepted.

The distance specification unit 1052 detects a distance to a body (finger 1101, etc.) making the touch operation relative to the capacitive touch panel 1031 of the touch panel of the input unit 1017. More specifically, the distance specification unit 1052 specifies a distance (coordinate of the position in the height direction) between the input unit 1017 and the body (hand, finger 1101, etc.) by capturing the change in capacitance of the capacitive touch panel 1031, and notifies this distance to the control unit 1053.

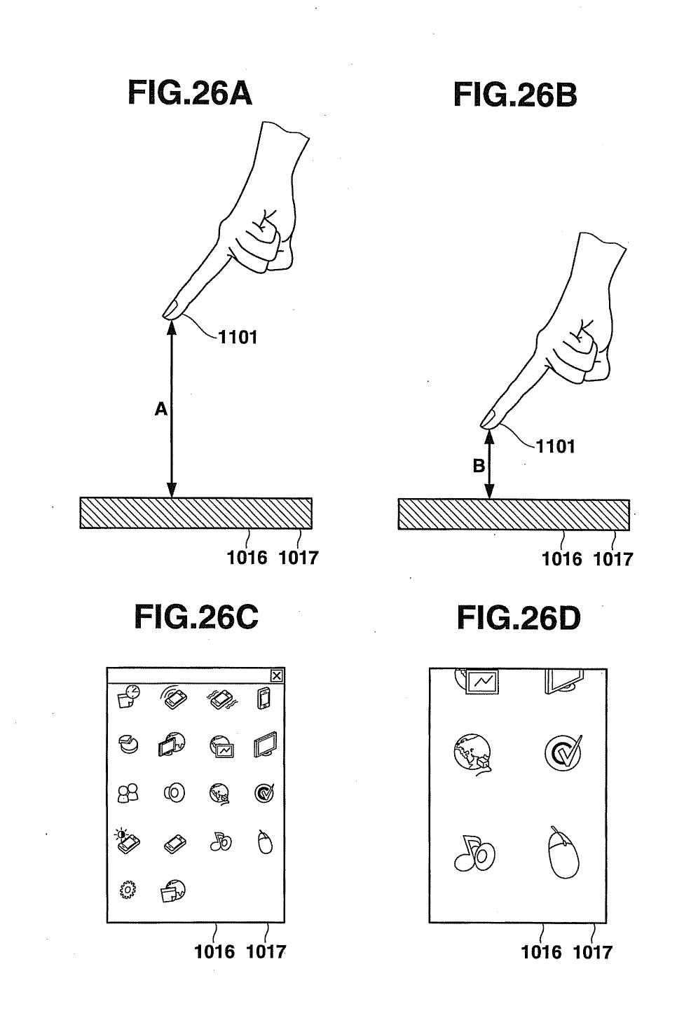

The control unit 1053 executes processing related to the object displayed on the display unit 1016, based on coordinates of the position on the two-dimensional plane accepted by the input operation acceptance unit 1051 and the distance (coordinate of the position in the height direction) specified by the distance specification unit 1052. More specifically, the control unit 1053 executes control to display an image showing a predetermined object so as to be included on the display screen of the display unit 1016. A specific example of an operation related to an object will be explained while referencing FIGS. 26A to 29B described later.

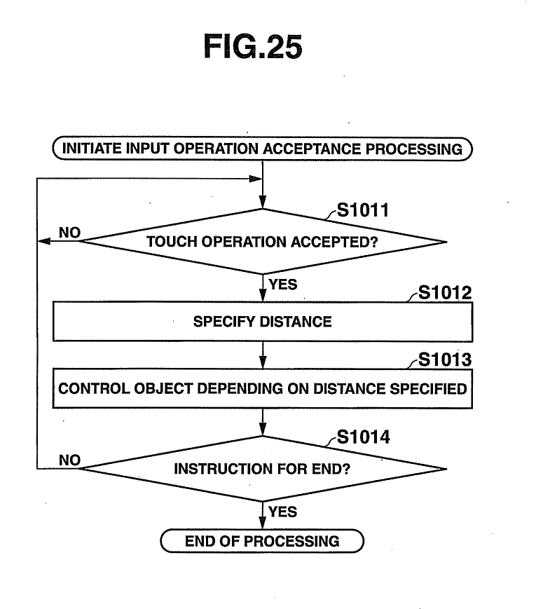

Next, input operation acceptance processing executed by such an information processing device 1001 of the functional configuration of FIG. 23 will be explained while referencing FIG. 25. FIG. 25 is a flowchart illustrating the flow of input operation acceptance processing executed by the information processing device 1001 of FIG. 22 having the functional configuration of FIG. 23.

The input operation acceptance processing is initiated on the condition of a power button (not illustrated) of the information processing device 1001 having been depressed by the user, upon which the following such processing is repeatedly executed.

In Step S1011, the input operation acceptance unit 1051 determines whether or not a touch operation by the user to the touch panel has been accepted. In a case of a touch operation by the user to the touch panel not having been performed, it is determined as NO in Step S1011, and the processing is returned back to Step S1011. More specifically, in a period until a touch operation is performed, the determination processing of Step S1011 is repeatedly executed, and the input operation acceptance processing enters a standby state. Subsequently, in a case of a touch operation having been performed, it is determined as YES in Step S1011, and the processing advances to Step S1012.

In Step S1012, the distance specification unit 1052 specifies the distance (coordinate of a position in the height direction) between the touch panel of the input unit 1017 and a body such as a hand or finger opposing the touch panel.

In Step S1013, the control unit 1053 executes processing related to the object displayed on the display unit 1016, depending on the coordinates of a position accepted by the input operation acceptance unit 1051, i.e. coordinates on a two-dimensional plane at which a touch operation was made, and a distance (coordinate of a position in the height direction) detected by the distance specification unit 1052. A specific example of processing related to the object will be explained while referencing FIGS. 26A through 29B described later.

In Step S1014, the CPU 1011 determines whether or not there is an instruction of input operation acceptance end. In a case of there not being an instruction of input operation acceptance end, it is determined as NO in Step S1014, and the processing is returned to Step S1011. More specifically, in a period until there is an instruction of input operation acceptance end, the processing of Steps S1011 to S1014 is repeatedly performed.

By configuring in this way, it is possible to control a desired object, by repeating a touch operation on the touch panel, in a period until the user performs an instruction of input operation acceptance end. Subsequently, in a case of an instruction of input operation acceptance end being made by the user performing a predetermined operation to the information processing device 1001, for example, it is determined as YES in Step S1014, and the input operation acceptance processing comes to an end.

Next, a specific example of processing related to an object in accordance with an operation to the input unit 1017 will be explained.

FIGS. 26A, 26B, 26C and 26D show states in which a touch operation is made on the input unit 1017 of the information processing device in FIG. 22.

As shown in FIG. 26A, in a case of the finger 1101 being separated by the distance A from the input unit 1017, icons (one type of object) displayed on the display of the display unit 1016 are set to be displayed with a size of the display ratio a shown in FIG. 26C.

In this case, as shown in FIG. 26B, when the finger 1101 approaches the input unit 1017 at the distance B, which is shorter than the distance A, the icons displayed on the display of the display unit 1016 are displayed with a size of the display ratio b enlarged from the display ratio a.

It should be noted that it is sufficient for the magnification ratio of the icons to vary depending on the distance; however, in the present embodiment, the magnification ratio is set to decrease in proportion to the distance. In other words, in the examples of FIGS. 26A, 26B, 26C and 26D, the display ratio b is (A/B) times the display ratio a. It should be noted that, although the display ratio of icons displayed on the display of the display unit 1016 increases when the distance n between the input unit 1017 and the finger decreases in the present embodiment, it is not limited thereto.

For example, it may be configured to decrease the display ratio of icons displayed on the display of the display unit 1016 when the distance n between the input unit 1017 and the finger increases.

Next, an example of changing processing related to an object, depending on a difference in the distance between the finger 1101 and the input unit 1017, even in a case of making an operation (hereinafter referred to as a “flick operation”) to move the finger 1101 substantially in parallel to the display screen (two-dimensional plane) of the display unit 1016 will be explained.

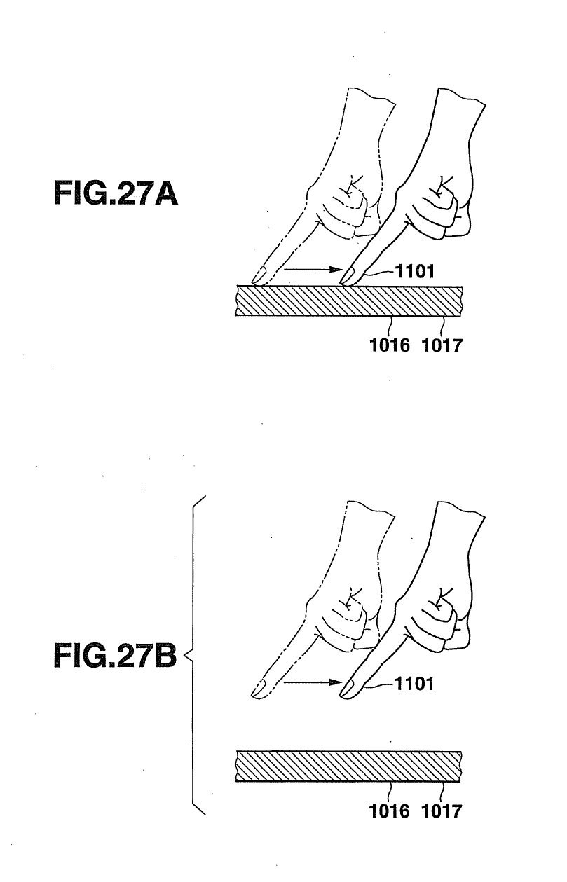

FIGS. 27A and 27B show states in which a flick operation is made on the input unit 1017 of the information processing device in FIG. 22.

As shown in FIG. 27A, in a case of the user making a flick operation with the distance between the input unit 1017 and the finger 1101 being 0, i.e. in a case of making a flick operation by maintaining a state contacting the finger 1101 to the input unit 1017, the control unit 1053 executes first processing as the processing related to the object.

In contrast, as shown in FIG. 27B, in a case of the user making a flick operation in a state of the distance between the input unit 1017 and the finger 1101 being far, i.e. in a case of making a flick operation by maintaining a state in which the finger 1101 is in noncontact relative to the input unit 1017, the control unit 1053 executes second processing as the processing related to the object.

Herein, the first processing and second processing may be any processing so long as being different processing from each other; however, in the present embodiment, processing to skip a page of a book or notes (one type of object) being displayed on the display unit 1016 is adopted as the first processing, and processing to change a file (separate type of object) displayed on the display unit 1016 is adopted as the second processing.

Next, an example of executing processing related to an object, in accordance with a sequence of operations of clenching and opening a hand 1102 over the input unit 1017 will be explained.

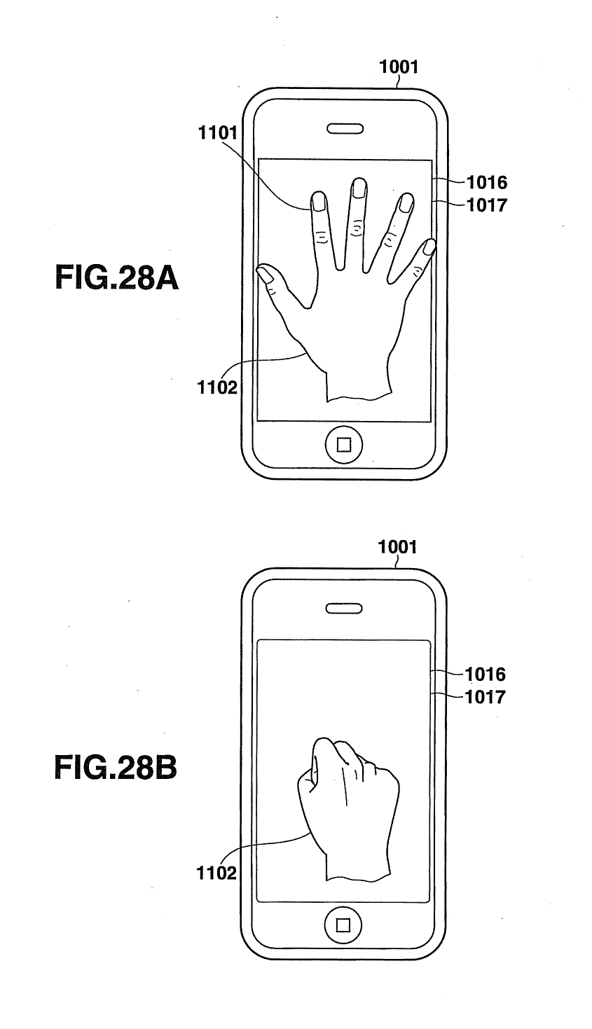

FIGS. 28A and 28B show states in which an operation to clench or open the hand 1102 is made above the input unit 1017 of the information processing device in FIG. 22.

In a case of making the series of movements (gestures) to transition from the state shown in FIG. 28A to the state shown in FIG. 28B, i.e. gesture to transition from the state spreading the hand 1102 to the state clenching the hand 1102 when the distance between the input unit 1017 and the hand 1102 is being separated, i.e. when the hand 1102 is in a noncontact state relative to the input unit 1017, the control unit 1053 recognizes the gesture, and executes processing pre-associated with this gesture. In this case, although the processing associated with this gesture is not particularly limited, in the present embodiment, processing to erase a file being displayed on the display unit 1016 is adopted.

It should be noted that the type and number of gestures are not particularly limited to the examples of FIGS. 28A and 28B, and any number of gestures of any type can be adopted. For example, although not illustrated, a gesture transitioning from a state opening to a state clenching the hand 1102, or gestures repeating the clenching and opening of the hand 1102 can be adopted. In other words, it is possible to adopt N types of gestures (N being any integer value of at least 1). In this case, any distinct processing can be associated with each of the N types of gestures, respectively.

Next, an example of changing the processing related to an object depending on a difference in the distance between the finger 1101 and the input unit 1017, even in a case of making an operation causing the finger 1101 to rotate substantially in parallel to the display screen (two-dimensional plane) of the display unit 1016 (hereinafter referred to as “rotation operation”), will be explained.

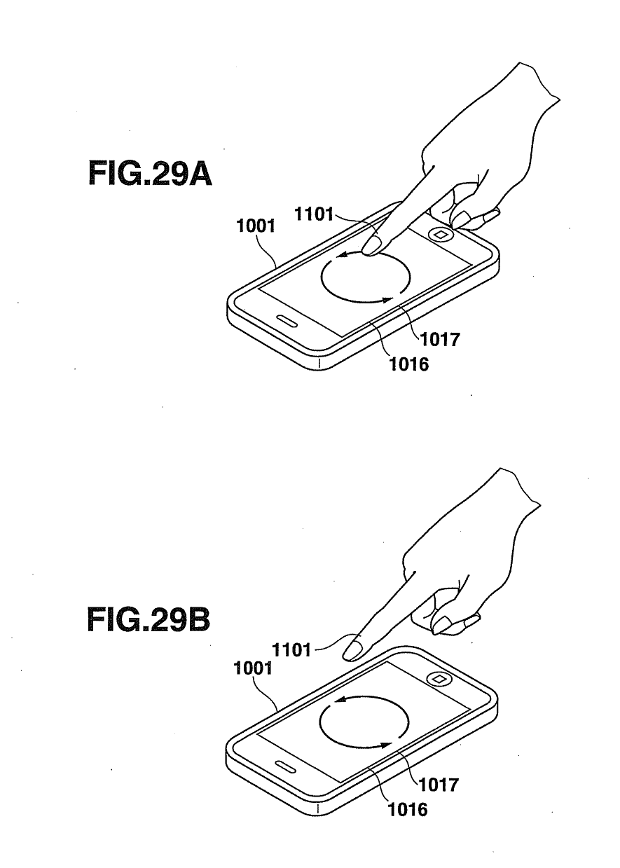

FIGS. 29A and 29B show states in which a rotation operation is made on the input unit 1017 of the information processing device in FIG. 22.

As shown in FIG. 29A, in a case of the user making a rotation operation while maintaining a state in which the distance between the input unit 1017 and the finger 1101 is 0, i.e. in a state in which the finger 1101 is contacting the input unit 1017, the control unit 1053 executes the first processing as the processing related to the object.

In contrast, as shown in FIG. 29B, in a case of the user making a rotation operation while maintaining a state in which the distance between the input unit 1017 and the finger 1101 is far, i.e. in a state in which the finger 1101 is in noncontact with the input unit 1017, the control unit 1053 executes the second processing as the processing related to the object.

Herein, the first processing and second processing may be any processing so long as being different processing from each other; however, in the present embodiment, processing to rotate an object 1103 being displayed on the display unit 1016 by following a trajectory of the finger 1101 making the rotation operation is adopted as the first processing, and processing to rotate this object a predetermined angle is adopted as the second processing.

It should be noted that, although it is sufficient for the rotation angle of the object 1103 to be variable depending on the distance, in the present embodiment, it is made substantially coincident with the rotation angle of the finger 1101 in a case of the distance being 0, and becomes smaller than the reference angle in proportion to the distance. In other words, if the distance is defined as n, the rotation angle of the object 1103 is (1/n) times a reference angle.

As explained in the foregoing, the information processing device 1001 of the present embodiment includes the input operation acceptance unit 1051, distance specification unit 1052, and control unit 1053.

The input operation acceptance unit 1051 accepts movement of a body that is substantially parallel to the display surface (two-dimensional plane) of the display unit 1016 on which the touch panel is laminated, as a touch operation to the touch panel.

The distance specification unit 1052 detects a distance from the display surface (two-dimensional plane) of the display unit 1016 for the body in a case of a touch operation having been made.

The control unit 1053 variably controls the execution of processing related to an object displayed, based on the type of touch operation accepted by the input operation acceptance unit 1051 (types differing depending on the trajectory of movement of the subject), and the distance detected by the distance specification unit 1052.

It is thereby possible to perform various instructions for processing related to an object, by simply intuitively performing a gesture operation (intuitive touch operation of making the body such as a finger or hand move), even for a user inexperienced in operations on the touch panel. It is thereby possible to easily instruct processing of an object, even for a user inexperienced in the touch panel.

Furthermore, the control unit 1053 of the information processing device 1001 of the present embodiment is configured so as to control processing related to the object and associated with a gesture operation (touch operation). It is thereby possible to perform various instructions for processing related to an object, by simply intuitively performing a gesture operation (intuitive touch operation of opening or closing a hand or finger), even for a user inexperienced in operations on the touch panel. It is thereby possible to easily instruct processing of an object, even for a user inexperienced in the touch panel.

Furthermore, the control unit 1053 of the information processing device 1001 of the present embodiment is configured so as to control processing related to an object and associated with the distance specified by the distance specification unit 1052. It is thereby possible to perform various instructions for processing related to an object, by simply changing the distance when intuitively performing a gesture operation, even for a user inexperienced in operations on the touch panel. It is thereby possible to easily instruct processing of an object, even for a user inexperienced in the touch panel.

Furthermore, the control unit 1053 of the information processing device 1001 of the present embodiment is configured so as to change the display ratio of an object displayed on the display surface of the display unit 1016, depending on the distance specified by the distance specification unit 1052. It is thereby possible to change the display ratio of an object, by simply changing the distance when intuitively performing a gesture operation, even for a user inexperienced in operations on the touch panel. It is thereby possible to easily instruct a change in the magnification of an object, even for a user inexperienced in the touch panel.

Furthermore, the control unit 1053 of the information processing device 1001 of the present embodiment is configured so as to execute control to either skip a page of the object displayed on the display surface of the display unit 1016, or change the object, depending on the distance specified by the distance specification unit 1052. It is thereby possible to change control of the object, by simply changing the distance when intuitively performing a gesture operation, even for a user inexperienced in operations on the touch panel. It is thereby possible to easily instruct a change in the control of an object, even for a user inexperienced in the touch panel.

Furthermore, the control unit 1053 of the information processing device 1001 of the present embodiment is configured so as to control processing related to an object and associated with a rotation operation on the object displayed on the display surface of the display unit 1016 accepted by the input operation acceptance unit 1051, depending on the distance detected by the distance specification unit 1052. It is thereby possible to change control of the object depending on the rotation operation, by simply changing the distance when intuitively performing a gesture operation, even for a user inexperienced in operations on the touch panel. It is thereby possible to easily instruct a change in the control of an object by simply performing a rotation operation, even for a user inexperienced in the touch panel.

Furthermore, the touch panel of the information processing device 1001 of the present embodiment is configured by a capacitive touch panel and a resistive touch panel.

In this case, it is possible to protect the resistive touch panel 1032 by the surface of the capacitive touch panel 1031. Furthermore, it is possible to detect the coordinates of a position at which a touch operation is made in a noncontact state and the distance between the finger 1101 and the capacitive touch panel 1031 by way of the capacitive touch panel 1031, as well as being able to detect with more detail the coordinates of a position at which a touch operation is made by way of the resistive touch panel 1032, in a case of contact.

It should be noted that the present invention is not to be limited to the aforementioned embodiments, and that modification, improvements, etc. in a scope that can achieve the object of the present invention are included in the present invention.

Although the capacitive touch panel 1031 and the resistive touch panel 1032 are laminated in this sequence over the entirety of the display screen of the display of the display unit 1016 in the aforementioned embodiments, it is not limited thereto. For example, the resistive touch panel 1032 and the capacitive touch panel 1031 may be laminated in this sequence over the entirety of the display screen of the display of the display unit 1016.

In addition, although the distance specification unit 1052 multiply specifies distances between the input unit 1017 and a hand, finger or the like from the change in capacitance of the capacitive touch panel 1031 constituting the input unit 1017 in the aforementioned embodiments, it is not limited thereto. For example, the distance specification unit 1052 may specify the distance detected by an ultrasonic sensor, infrared sensor, image-capturing device, or the like not illustrated.

In other words, in the aforementioned embodiments, the input operation acceptance unit 1051 accepts, as a touch operation, an operation of a movement of the position in two dimensions of a body (e.g., hand or finger) in a direction substantially parallel to the display screen (two-dimensional plane) of the display unit 1016. In addition, the distance specification unit 1052 detects the distance of the body from the display screen, i.e. position of the body in a direction substantially parallel to a normal of the display screen.

In view of this, the aforementioned embodiment is equivalent to the matter of the input operation acceptance unit 1051 and the distance specification unit 1052 accepting an operation of movement of a body in three-dimensional directions relative to the display screen of the display unit 1016 defined as the reference plane. Therefore, the input operation acceptance unit 1051 and the distance specification unit 1052 are collectively referred to as a “three-dimensional operation acceptance unit” hereinafter.

In this case, the reference plane is not particular required to be the display screen of the display unit 1016, and may be any plane. In this case, for the reference plane, it is not necessary to use a plane that can be seen by the user with the naked eye, and a plane within any body may be used, or a virtual plane may be defined as the reference plane.

In addition, a three-dimensional position detection unit that measures a position of the body in three dimensions is configured as the capacitive touch panel 1031 and the resistive touch panel 1032 in the aforementioned embodiments; however, it is not particularly limited thereto, and can be configured by combining any number of position detection units of any type. Herein, the aforementioned distance is nothing but a position in a normal vector direction of the reference surface; therefore, detecting the distance is nothing but detecting a position in the normal vector direction of the reference surface.

In summary, it is sufficient if the information processing device to which the present invention is applied has the following such functions, and the embodiments thereof are not particularly limited to the aforementioned embodiments.

In other words, the information processing device to which the present invention is applied includes:

a three-dimensional position detection function of detecting a position of a body in three-dimensional directions relative to a reference plane;

a three-dimensional operation acceptance function of recognizing a movement of the body in three-dimensional directions based on each position in the three-dimensional directions of the body temporally separated and detected multiple times, and accepting the recognition result thereof as an instruction operation related to an object; and

a control function of variably controlling processing related to this object, depending on the instruction operation accepted.

In addition, although the display ratio of an icon displayed on the display of the display unit 1016 is changed depending on the distance between the input unit 1017 and the finger 1101 in the aforementioned embodiments, it is not limited thereto. For example, it may be configured so as to be displayed by centering at a location in the vicinity of the finger 1101, depending on the distance between the input unit 1017 and the finger 1101.

In addition, although the information processing device 1001 to which the present invention is applied is explained with a smart phone as an example in the aforementioned embodiments, it is not particularly limited thereto.

For example, the present invention can be applied to general electronic devices having an image-capturing function. More specifically, for example, the present invention is applicable to notebook-type personal computers, printers, television sets, video cameras, digital cameras, portable navigation devices, portable telephones, portable videogame machines, and the like.

The aforementioned sequence of processing can be made to either be executed by hardware or executed by software.

That is, the functional configuration in FIG. 23 is merely an example and is not particularly limiting. In other words, it is sufficient that the information processing device 1001 be provided with functions capable of executing the aforementioned sequence of processing as a whole, and the kinds of functional blocks used in order to realize these functions are not particularly limited to the example in FIG. 23.

In addition, the individual functional blocks may be configured by hardware units, may be configured by software units, and may be configured by combinations thereof.

If a sequence of processing is executed by software, a program constituting the software is installed to the computer or the like from a network or a recording medium.

The computer may be a computer incorporating special-purpose hardware. In addition, the computer may be a computer capable of executing various functions by installing various programs, for example, a general-purpose personal computer.

The recording medium containing such a program is configured not only by the removable media 1041 in FIG. 22 that is distributed separately from the main body of the device in order to provide the program to the user, but also is configured by a recording medium provided to the user in a state incorporated in the main body of the equipment in advance, or the like. The removable media 1041 is constituted by, for example, a magnetic disk (including floppy disks), an optical disk, a magneto-optical disk or the like. The optical disk is, for example, a CD-ROM (Compact Disk-Read Only Memory), DVD (Digital Versatile Disk), or the like. The magneto-optical disk is, for example, an MD (Mini-Disk), or the like. In addition, the recording medium provided to the user in a state incorporated with the main body of the equipment in advance is constituted by the ROM 1012 of FIG. 22 in which a program is recorded, a hard disk included in the storage unit 1018 of FIG. 22, and the like.

It should be noted that the steps describing the program recorded in the recording medium naturally include processing performed chronologically in the described order, but is not necessarily processed chronologically, and also includes processing executed in parallel or separately.

Furthermore, the terminology of system in the present specification is intended to mean the overall equipment configured by a plurality of devices, a plurality of means, etc.

Although several embodiments of the present invention have been explained in the foregoing, these embodiments are merely examples, and do not limit the technical scope of the present invention. The present invention can be attained by various other embodiments, and further, various modifications such as omissions and substitutions can be made in a scope not departing from the spirit of the present invention. These embodiments and modifications thereof are included in the scope and gist of the invention described in the present specification and the like, and are encompassed in the invention recited in the attached claims and equivalents thereof.

What is claimed is:

1. An information processing device comprising:
a three-dimensional position detection unit that detects a position of a body relative to a reference plane in three-dimension directions;
a three-dimensional operation acceptance unit that recognizes movement of the body in three-dimensional directions based on each position in three-dimensional directions of the body temporally separated and detected multiple times, by way of the three-dimensional position detection unit, and accepts a recognition result thereof as an instruction operation related to an object; and
a control unit that variably controls processing related to the object, depending on the instruction operation accepted by the three-dimensional operation acceptance unit and a distance of the body in a normal vector direction from the reference plane.

2. The information processing device according to claim 1,
wherein the three-dimensional position detection unit includes a touch panel laminated on a display screen, the display screen being the reference plane,
wherein a plurality of types of touch operations to which different processing is respectively associated is assigned as processing related to the object, depending on a distance in a normal vector direction of the display screen,
wherein the three-dimensional operation acceptance unit includes:
an input operation acceptance unit that accepts a movement operation of a body in two-dimensional directions that are substantially parallel to the display screen; and
a distance specification unit that specifies a distance of the body in a normal vector direction from the display screen, and
wherein the control unit
recognizes a touch operation executed among the plurality of types of touch operations, based on the movement operation accepted by way of the input operation acceptance unit and the distance specified by way of the distance specification unit, and controls processing related to the object in accordance with the touch operation.

3. The information processing device according to claim 2,
wherein the control unit executes either processing to skip a page of an object displayed on the display screen, or to read a separate object, depending on the distance specified by way of the distance specification unit.

4. The information processing device according to claim 2,
Wherein the control unit executes processing to either rotate an object displayed on the display screen to an arbitrary angle or to rotate to a prescribed angle, depending on the distance specified by way of the distance specification unit.

5. The information processing device according to claim 2,
wherein, among objects disposed on a plurality of layers displayed on the display screen, the control unit executes control of depress processing on the object disposed on any layer, depending on the distance specified by way of the distance specification unit.

6. The information processing device according to claim 2,
Wherein the control unit executes control to either select a plurality of objects displayed on the display screen, or to move only a part of the objects among the plurality of objects, depending on the distance specified by way of the distance specification unit.

7. The information processing device according to claim 2,
Wherein the control unit executes control to either display an object displayed on the display screen as a separate file of the same category, or to display as a separate file of a separate category, depending on the distance specified by way of the distance specification unit.

8. The information processing device according to claim 2,
wherein the control unit executes control to display an object displayed on the display screen to be enlarged or reduced in size.

9. The information processing device according to claim 2,
wherein the control unit executes to control to either rotate or select the object, depending on a movement of the body in three-dimensional directions recognized by way of the three-dimensional operation acceptance unit.

10. The information processing device according to claim 2,
wherein the control unit executes control to select different character types as a character of conversion candidates acquired based on a result of character recognition, depending on the distance specified by way of the distance specification unit.

11. The information processing device according to claim 2, further comprising an image-capturing unit that captures an image of a subject,
wherein the control unit executes control to capture an image by controlling the image-capturing unit according to an instruction based on any touch panel among a plurality of panels configuring the touch panel laminated, depending on the distance specified by way of the distance specification unit.

12. The information processing device according to claim 2, further comprising an image-capturing unit that captures an image of a subject,
wherein the control unit executes control to either initiate continuous shoot by way of the image-capturing unit, or to stop the continuous shoot, depending on the distance specified by way of the distance specification unit.

13. An information processing method executed by an information processing device that controls processing related to an object, the method comprising the steps of:
detecting a position a body in three-dimensional directions relative to a reference plane;
recognizing movement of the body in three-dimensional directions based on each position in three-dimensional directions of the body temporally separated and detected multiple times in the detecting step, and accepting a recognition result thereof as an instruction operation related to an object; and
variably controlling processing related to the object, depending on the instruction operation accepted in the recognizing step, and a distance of the body in a normal vector direction from the reference plane.

14. A computer readable recording medium in which a program for causing a computer that controls an information processing device controlling processing related to an object to realize:
a three-dimensional position detection function of detecting a position of a body relative to a reference plane in three-dimension directions;
a three-dimensional operation acceptance function of recognizing movement of the body in three-dimensional directions based on each position in three-dimensional directions of the body temporally separated and detected multiple times, by way of the three-dimensional position detection function, and accepting a recognition result thereof as an instruction operation related to an object; and
a control function of variably controlling processing related to the object, depending on the instruction operation accepted by way of the three-dimensional operation acceptance function and a distance of the body in a normal vector direction from the reference plane.

15. An information processing device, comprising:
a three-dimensional position detection unit that detects a body relative to a reference plane in three-dimension directions;
a three-dimensional operation acceptance unit that recognizes movement of the body in three-dimensional directions based on each position in three-dimensional directions of the body temporally separated and detected multiple times, by way of the three-dimensional position detection unit, and accepts a recognition result thereof as an instruction operation related to an object; and
a control unit that variably controls processing related to the object, depending on the instruction operation accepted by the three-dimensional operation acceptance unit.

16. The information processing device according to claim 15,
wherein the three-dimensional position detection unit includes a touch panel laminated on a display screen, the display screen being the reference plane,
wherein the three-dimensional operation acceptance unit includes:
an input operation acceptance unit that accepts a movement of a body in two-dimensional directions that are substantially parallel to the display screen as a touch operation to the touch panel; and
a distance specification unit that specifies a distance of the body from the display screen as a position of the body in a normal vector direction of the display screen.

17. The information processing device according to claim 16,
wherein the control unit controls processing related to an object, and associated with the touch operation in advance.

18. The information processing device according to claim 16,
wherein the control unit controls processing related to an object, and associated to a distance specified by way of the distance specification unit.

19. The information processing device according to claim 18,
Wherein the control unit executes processing to change a display ratio of an object displayed on the display screen, depending on the distance specified by way of the distance specification unit.

20. The information processing device according to claim 18,
wherein the control unit executes control to either skip a page of an object displayed on the display screen or change the object, depending on the distance specified by way of the distance specification unit.

21. The information processing device according to claim 18,
wherein the control unit controls processing related to an object, and associated to a rotation operation on an object displayed on the display screen accepted by way the three-dimensional operation acceptance unit, depending on the distance specified by way of the distance specification unit.

22. The information processing device according to claim 16,
wherein the touch panel is comprised of a capacitive touch panel and a resistive touch panel.

23. The information processing device according to claim 17,
wherein the touch panel is comprised of a capacitive touch panel and a resistive touch panel.

24. The information processing device according to claim 18,
wherein the touch panel is comprised of a capacitive touch panel and a resistive touch panel.

25. The information processing device according to claim 19,
wherein the touch panel is comprised of a capacitive touch panel and a resistive touch panel.

26. The information processing device according to claim 20,
wherein the touch panel is comprised of a capacitive touch panel and a resistive touch panel.

27. The information processing device according to claim 21,
wherein the touch panel is comprised of a capacitive touch panel and a resistive touch panel.

28. An information processing method executed by an information processing device that controls processing related to an object, the method comprising the steps of:
detecting a position a body in three-dimensional directions relative to a reference plane;
recognizing movement of the body in three-dimensional directions based on each position in three-dimensional directions of the body temporally separated and detected multiple times in the detecting step, and accepting a recognition result thereof as an instruction operation related to an object; and
variably controlling processing related to the object, depending on the instruction operation accepted in the recognizing step.

29. A computer readable recording medium in which a program for causing a computer that controls an information processing device controlling processing related to an object to realize:
a three-dimensional position detection function of detecting a position of a body relative to a reference plane in three-dimension directions;
a three-dimensional operation acceptance function of recognizing movement of the body in three-dimensional directions based on each position in three-dimensional directions of the body temporally separated and detected multiple times, by way of the three-dimensional position detection function, and accepting a recognition result thereof as an instruction operation related to an object; and
a control function of variably controlling processing related to the object, depending on the instruction operation accepted by way of the three-dimensional operation acceptance function.
